(19) United States
(12) Patent Application Publication
(10) Pub. No.: US 2026/0231266 A1
(43) Pub. Date: Aug. 6, 2026

(54) COMMUNICATING CAPABILITIES FOR PROTOCOL DATA UNIT SESSIONS

(71) Applicant: Lenovo (United States) Inc., Morrisville, NC (US)

(72) Inventor: Roozbeh Atarius, La Jolla, CA (US)

(73) Assignee: Lenovo (United States) Inc., Morrisville, NC (US)

(21) Appl. No.: 19/047,552

(22) Filed: Feb. 6, 2025

(51) Int. Cl. H04W 76/16; H04L 5/00; H04W 8/22; H04W 76/12

(52) U.S. Cl. CPC H04W 76/16; H04L 5/0053; H04W 8/22; H04W 76/12

(57) ABSTRACT

Various aspects of the present disclosure relate to communicating a connect protocol for a protocol data unit session or a packet data network connection. A user equipment (UE) transmits a request message to establish a multi-access (MA) protocol data unit (PDU) session, where the request message includes an indication of an access traffic steering-switching-splitting (ATSSS) steering functionality and steering mode for the MA PDU session. In some examples, the request message further includes an indication of a connect protocol for the MA PDU session. The UE receives, from a network equipment (NE), a response message based on the request message. The response message may be associated with whether the NE is capable of supporting the ATSSS steering functionality and steering mode. For example, the NE may transmit a rejection message including an error cause value indicating that the ATSSS steering functionality and steering mode is not supported by the NE.

### TECHNICAL FIELD

The present disclosure relates to wireless communications, and more specifically to communicating capabilities for multi-access (MA) protocol data unit (PDU) sessions.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to transmit, to an NE, a request message to establish an MA PDU session, where the request message includes an indication of an access traffic steering, switching, splitting (ATSSS) steering functionality and steering mode for the MA PDU session, and receive, from the NE, a response message based on the request message, where the response message is associated with whether the NE is capable of supporting the ATSSS steering functionality and steering mode.

A processor for wireless communication is described. The processor may be configured to, capable of, or operable to perform one or more operations as described herein. For example, the processor may be configured to, capable of, or operable to transmit, to an NE, a request message to establish an MA PDU session, where the request message includes an indication of an ATSSS steering functionality and steering mode for the MA PDU session, and receive, from the NE, a response message based on the request message, where the response message is associated with whether the NE is capable of supporting the ATSSS steering functionality and steering mode.

A method performed or performable by a UE for wireless communication is described. The method may include transmitting, to an NE, a request message to establish an MA PDU session, where the request message includes an indication of an ATSSS steering functionality and steering mode for the MA PDU session, and receiving, from the NE, a response message based on the request message, where the response message is associated with whether the NE is capable of supporting the ATSSS steering functionality and steering mode.

In some implementations of the UE, the processor, and the method described herein, the response message includes a cause value indicating a rejection of the MA PDU session. In some implementations, the cause value includes a 5G session management (5GSM) cause value or an evolved packet system (EPS) session management (ESM) cause value.

In some implementations of the UE, the processor, and the method described herein, the UE may transmit, to the NE, a subsequent request message to establish the MA PDU session, where the subsequent request message includes an indication of an alternative ATSSS steering functionality and steering mode for the MA PDU session based on the NE being capable of supporting the alternative ATSSS steering functionality and steering mode.

In some implementations of the UE, the processor, and the method described herein, the UE may refrain from establishing the MA PDU session based on the cause value.

In some implementations of the UE, the processor, and the method described herein, the ATSSS steering functionality and steering mode includes at least one of a multipath QUIC (MPQUIC) Internet protocol (MPQUIC-IP) functionality, an MPQUIC Ethernet (MPQUIC-E) functionality, or an MPQUIC user datagram protocol (MPQUIC-UDP) functionality, and the indication is included in an ATSSS steering functionality and steering mode information element field of a 5GSM capability information element.

In some implementations of the UE, the processor, and the method described herein, the ATSSS steering functionality and steering mode includes an MPQUIC functionality, the indication is included in a 5GSM capability information element, and the 5GSM capability information element includes an indication of a connect protocol for the MA PDU session.

In some implementations of the UE, the processor, and the method described herein, the ATSSS steering functionality and steering mode includes an MPQUIC functionality, the indication is included as an ATSSS request protocol configuration options (PCO) parameter, and the request message further includes a tunneling indicator PCO parameter that indicates a connect protocol for the MA PDU session.

In some implementations of the UE, the processor, and the method described herein, the response message includes an additional tunneling indicator PCO parameter that indicates an acknowledgement of the connect protocol, the tunneling indicator PCO parameter and the additional tunneling indicator PCO parameter share a same container identifier, and the UE may establish the MA PDU session according to the connect protocol based on receiving the response message.

In some implementations of the UE, the processor, and the method described herein, the ATSSS steering functionality and steering mode includes at least one of an MPQUIC-IP functionality or an MPQUIC-E functionality, and where the response message includes one or more rules associated with an alternative ATSSS steering functionality and steering mode that includes an MPQUIC-UDP functionality.

In some implementations of the UE, the processor, and the method described herein, the UE may transmit, to the NE, a subsequent request message to establish the MA PDU session, where the subsequent request message includes an indication of the alternative ATSSS steering functionality and steering mode based on the NE being capable of supporting the alternative ATSSS steering functionality and steering mode.

In some implementations of the UE, the processor, and the method described herein, the UE may refrain from establishing the multi-access PDU session based on the response message including the one or more rules associated with the alternative ATSSS steering functionality and steering mode.

In some implementations of the UE, the processor, and the method described herein, the UE may transmit, to an additional NE, a tunnel establishment request message that indicates a connect protocol for the MA PDU session, where the connect protocol includes at least one of an IP or an Ethernet protocol. In some implementations of the UE, the processor, and the method described herein, the UE may establish the MA PDU session in accordance with the connect protocol and the ATSSS steering functionality and steering mode. In some implementations of the UE, the processor, and the method described herein, the UE may receive, from the additional NE, an indication that the connect protocol is not allowed based on the response message including the one or more rules associated with the alternative ATSSS steering functionality and steering mode.

An NE for wireless communication is described. The NE may be configured to, capable of, or operable to perform one or more operations as described herein. For example, the NE may be configured to, capable of, or operable to receive, from a UE, a request message to establish an MA PDU session, where the request message includes an indication of an ATSSS steering functionality and steering mode for the MA PDU session, and transmit, to the UE, a response message based on the request message, where the response message is associated with whether the NE is capable of supporting the ATSSS steering functionality and steering mode.

A processor for wireless communication is described. The processor may be configured to, capable of, or operable to perform one or more operations as described herein. For example, the processor may be configured to, capable of, or operable to receive, from a UE, a request message to establish an MA PDU session, where the request message includes an indication of an ATSSS steering functionality and steering mode for the MA PDU session, and transmit, to the UE, a response message based on the request message, where the response message is associated with whether the NE is capable of supporting the ATSSS steering functionality and steering mode.

A method performed or performable by an NE for wireless communication is described. The method may include receiving, from a UE, a request message to establish an MA PDU session, where the request message includes an indication of an ATSSS steering functionality and steering mode for the MA PDU session, and transmitting, to the UE, a response message based on the request message, where the response message is associated with whether the NE is capable of supporting the ATSSS steering functionality and steering mode.

In some implementations of the NE, the processor, and the method described herein, the response message includes a cause value indicating a rejection of the MA PDU session based on the NE lacking a capability to support the ATSSS steering functionality and steering mode.

In some implementations of the NE, the processor, and the method described herein, the cause value includes a 5GSM cause value or an ESM cause value.

In some implementations of the NE, the processor, and the method described herein, the NE may receive, from the UE, a subsequent request message to establish the MA PDU session, where the subsequent request message includes an indication of an alternative ATSSS steering functionality and steering mode for the MA PDU session based on the NE being capable of supporting the alternative ATSSS steering functionality and steering mode.

In some implementations of the NE, the processor, and the method described herein, the ATSSS steering functionality and steering mode includes at least one of an MPQUIC-IP functionality, an MPQUIC-E functionality, or an MPQUIC-UDP functionality, and where the indication is included in an ATSSS steering functionality and steering mode information element field of a 5GSM capability information element.

In some implementations of the NE, the processor, and the method described herein, the NE may establish the MA PDU session based on receiving the request message.

In some implementations of the NE, the processor, and the method described herein, the ATSSS steering functionality and steering mode includes an MPQUIC functionality, the indication is included in a 5GSM capability information element, and the 5GSM capability information element includes an indication of a connect protocol for the MA PDU session.

In some implementations of the NE, the processor, and the method described herein, the ATSSS steering functionality and steering mode includes an MPQUIC functionality, the indication is included as an ATSSS request PCO parameter, and the request message further includes a tunneling indicator PCO parameter that indicates a connect protocol for the MA PDU session.

In some implementations of the NE, the processor, and the method described herein, the response message includes an additional tunneling indicator PCO parameter that indicates an acknowledgement of the connect protocol, the tunneling indicator PCO parameter and the additional tunneling indicator PCO parameter share a same container identifier, and the NE may establish the MA PDU session according to the connect protocol based on receiving the request message.

In some implementations of the NE, the processor, and the method described herein, the ATSSS steering functionality and steering mode includes at least one of a an MPQUIC-IP functionality or an MPQUIC-E functionality, and where the response message includes one or more rules associated with an alternative ATSSS steering functionality and steering mode that includes an MPQUIC-UDP functionality.

In some implementations of the NE, the processor, and the method described herein, the NE may receive, from the UE, a subsequent request message to establish the MA PDU session, where the subsequent request message includes an indication of the alternative ATSSS steering functionality and steering mode based on the NE being capable of supporting the alternative ATSSS steering functionality and steering mode.

In some implementations of the NE, the processor, and the method described herein, the NE may establish the MA PDU session based on receiving the subsequent request message.

### BRIEF DESCRIPTION OF THE DRAWINGS

FIG. 1 illustrates an example of a wireless communications system in accordance with aspects of the present disclosure.

FIG. 2 illustrates an example of ATSSS-ST encoding in a 5GSM capability information element, in accordance with aspects of the present disclosure.

FIG. 3 illustrates an example of a 5GSM capability information element, in accordance with aspects of the present disclosure.

FIGS. 4 and 5 illustrate examples of tunneling indicator PCO parameter container contents, in accordance with aspects of the present disclosure.

FIGS. 6 and 7 illustrate examples of MA PDU session establishments, in accordance with aspects of the present disclosure.

FIG. 8 illustrates an example of a QUIC handshake and tunneling request, in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of a NE in accordance with aspects of the present disclosure.

FIG. 12 illustrates a flowchart of a method performed by a UE in accordance with aspects of the present disclosure.

FIG. 13 illustrates a flowchart of a method performed by a NE in accordance with aspects of the present disclosure.

### DETAILED DESCRIPTION

A wireless communications system may support wireless communications for one or more devices (e.g., UEs and NEs, among other examples) that transmit and/or receive signaling via an over-the-air interface (e.g., as part of a radio access network (RAN)). In some examples, a device may be capable of supporting multiple access networks, such as 5G or beyond and Wi-Fi. For example, access traffic steering, switching, splitting (ATSSS) is a feature that enables a device to simultaneously utilize a 3^{rd} Generation Partnership Project (3GPP) network (e.g., 5G, 4G) and a non-3GPP network (e.g., Wi-Fi) for a single data session (e.g., a multi-access (MA) protocol data unit (PDU) session). The device can steer traffic of a data flow to one of the networks, switch traffic of a data flow from one network to another without service interruption, and split traffic of a data flow to use both networks simultaneously. ATSSS steering modes and steering functionalities (ATSSS-ST) define how the traffic is distributed between the different networks, and are applicable to different protocols (e.g., Internet protocol (IP), Ethernet, user datagram protocol (UDP)).

3GPP Release 17 introduced ATSSS lower layer (ATSSS-LL) steering functionality and multipath transmission control protocol (MPTCP) steering functionality. 3GPP Release 18 added multipath QUIC (MPQUIC) steering functionality for UDP packets (referred to as MPQUIC-UDP), and 3GPP Release 19 expanded the MPQUIC steering functionality for IP packets and Ethernet packets (referred to as MPQUIC-IP and MPQUIC-E, respectively). When establishing an MA PDU session, a UE indicates its ATSSS-ST capabilities to a network. The network (e.g., an NE, such as a session management function (SMF)), interprets ATSSS-ST capability indications to provide appropriate support for the PDU session. However, the evolution of ATSSS steering functionalities across releases can lead to compatibility issues. For instance, current techniques lack support for indicating Release 19 ATSSS steering functionalities (e.g., MPQUIC-IP, MPQUIC-E). Moreover, a legacy NE from an earlier release may not support ATSSS steering functionalities from later releases and may not understand a capability indication that refers to such a functionality, which can lead to session establishment failures and/or use of less efficient communication methods. Additionally, conventional techniques may not provide fallback procedures to recover from or adapt to such scenarios.

The described techniques provide for communicating ATSSS-ST capability information with improved granularity. For example, according to the present disclosure, during MA PDU session establishment a UE may explicitly indicate support for MPQUIC-IP and/or MPQUIC-E functionality within a 5G session management (5GSM) capability information element or a protocol configuration options (PCO) parameter. In some cases, the UE can additionally indicate a connect protocol for a tunnel to be established in conjunction with the indicated ATSSS-ST functionality. The techniques described herein further provide methods and systems for establishing and managing MA PDU sessions for devices with differing ATSSS capabilities. For example, if an NE does not support the indicated ATSSS-ST capability and/or fails to interpret the indication, the NE can respond to the UE with an error message. Based on the error message, the UE may be aware that the NE is a legacy NE and may take appropriate action. For instance, the UE can re-request establishment of the MA PDU session using an ATSSS-ST capability supported by legacy NEs (e.g., ATSSS-LL, MPTCP) or can request session establishment from a different NE.

The techniques described herein may improve the efficiency and reliability of wireless communications by improving interoperability between devices and networks from different manufacturers or generations. For example, enabling more detailed and flexible communication of ATSSS-ST capabilities, as described herein, allows a UE to dynamically adapt to various network capabilities and limitations, establishing optimal connections even when interacting with NEs having varying levels of ATSSS-ST support. A UE receiving an error indication can adjust its approach or attempt alternative connection methods, leading to faster session establishment, reduced connection failures, and improved reliability. The described techniques further enhance user experience by enabling seamless transitions between different access technologies. Additionally, by optimizing establishment and management of MA PDU sessions as described herein, the UE and NEs can improve load balancing across available access networks, increasing communications efficiency and throughput. Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

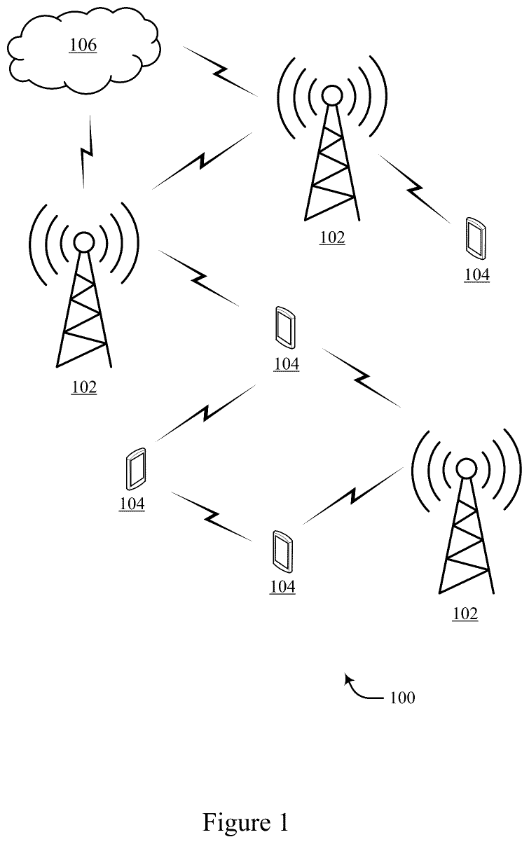

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

To connect to a network, a UE 104 can request establishment of a PDU session by transmitting a request message to the network. The UE 104 communicates (e.g., transmits, sends) data, information, requests, etc. to an NE 102 (e.g., a gNB), which communicates (e.g., transmits, sends) the data, information, requests, etc. to an appropriate function implemented by the CN 106. Similarly, a function of the CN 106 communicates (e.g., transmits, sends) data, information, requests, etc. to an NE 102 (e.g., a gNB), which communicates (e.g., transmits, sends) the data, information, requests, etc. to the UE 104. The functions of the CN 106 can include, but are not limited to, an access and mobility function (AMF), an SMF, a policy control function (PCF), and a user plane function (UPF). Additionally, these functions may be represented as, include, or be an example of a network node, such as an NE 102.

The techniques discussed herein provide for a UE 104 transmitting a request message to establish an MA PDU session with a network (e.g., the CN 106). The request message is transmitted to a network node, such as an AMF, an SMF, or the like. For example, a first NE 102 (e.g., a base station) may receive the request message and pass the request message (or information in the request message) to the network node, which may include or be an example of a second NE 102 (e.g., an AMF, an SMF). The request message includes an indication of an ATSSS steering functionality (also referred to herein as an ATSSS steering functionality and steering mode (ATSSS-ST)) and, in some cases, an indication of a connect protocol, for the PDU session, and this indication is included in at least one of an information element or a container. The ATSSS steering functionality can include, but is not limited to, ATSSS-LL, MPTCP, MPQUIC, MPQUIC-IP, MPQUIC-UDP, or MPQUIC-E. As described herein, an ATSSS steering functionality of MPQUIC-IP refers to an MPQUIC steering functionality to be implemented in conjunction with establishment of an IP tunnel for UDP data transmission, an ATSSS steering functionality of MPQUIC-E refers to an MPQUIC steering functionality to be implemented in conjunction with establishment of an Ethernet tunnel for UDP data transmission, and an ATSSS steering functionality of MPQUIC-UDP refers to an MPQUIC steering functionality to be implemented in conjunction with establishment of a UDP tunnel for UDP data transmission. The connect protocol can be, for example, at least one of type UDP, type IP, type ethernet, or type TCP. The ATSSS steering functionality and/or the connect protocol can be specified, for example, in a new information element, part of an existing information element, an existing container for PCO parameters, or a new container for PCO parameters.

The UE 104 receives a message based on the request message and a capability of the network node (e.g., the second NE 102) to support the indicated ATSSS steering functionality and/or connect protocol. The message is received from the network node or, in some cases, from the first NE 102, which passed the message (or information in the message) that the first NE 102 received from the network node. If the network node lacks the capability, the message may include an error cause value indicating that the requested ATSSS steering functionality is not supported. The UE 104 may refrain from continuing with the establishment procedure with the network node in such scenarios. Alternatively, if the network node is capable of supporting the requested ATSSS steering functionality and connect protocol, the message may include one or more rules for the PDU session. These rules describe the traffic steering, switching and splitting in the uplink direction, such as how the UE 104 is expected to utilize the access networks (e.g., 3GPP and/or non-3GPP) available to the UE 104.

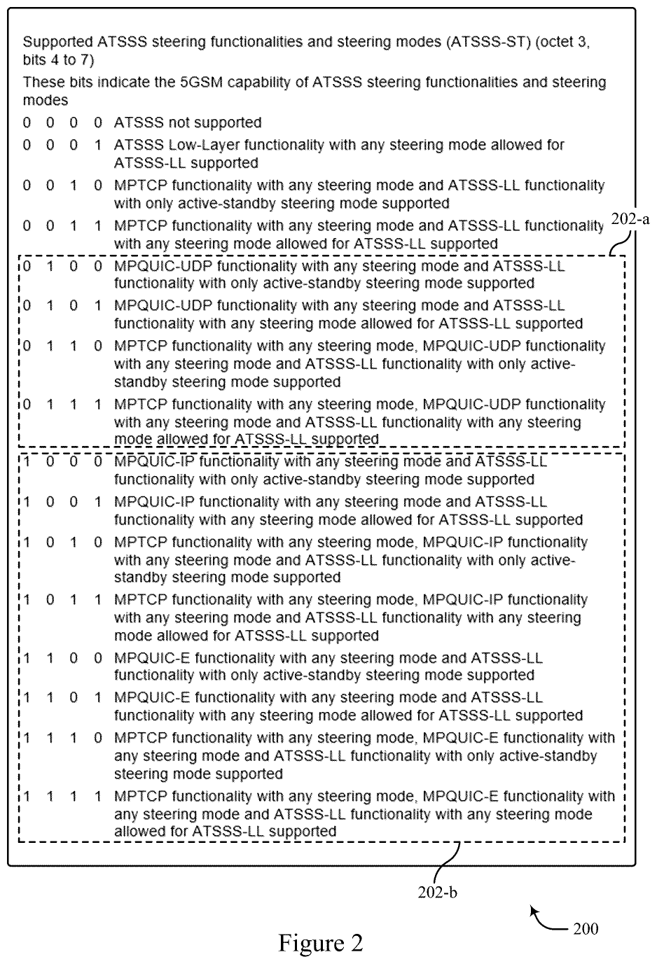

FIG. 2 illustrates an example 200 of ATSSS-ST encoding in a 5GSM capability information element in accordance with aspects of the present disclosure. The example 200 may implement or be implemented by aspects of the wireless communications system 100. For example, a UE (e.g., a UE 104) may indicate its ATSSS-ST capabilities to a network node (e.g., an NE 102, such as an AMF and/or an SMF) in accordance with the example 200 during establishment of an MA PDU session as described with reference to FIG. 1.

For example, the UE may transmit a request message that indicates a request to establish the PDU session. The request message may include a 5GSM capability information element that includes a set of information element fields, with at least one information element field indicating ATSSS-ST capabilities supported and/or preferred by the UE. This information element field may be referred to as an encoding (e.g., an ATSSS-ST encoding), and may be included in octet 3 with a length of four bits occupying bits 4 to 7 of the 5GSM capability information element. Values of the four bits can be mapped to a supported ATSSS-ST capability. As an example, an indication (also referred to herein as an encoding) that the UE supports MPTCP functionality with any steering mode and ATSSS-LL functionality with any steering mode can be identified as 0011.

Upon reception of the request message, the network node (e.g., the SMF) encodes an attribute “atsssCapab” based on the indicated ATSSS-ST capability. The SMF encodes the “atsssCapab” attribute as ATSSS_LL if the UE is capable of ATSSS-LL functionality with any steering mode allowed for ATSSS-LL supported and depending on an associated data network name (DNN) configuration. If the UE is capable of MPTCP functionality with any steering mode and ATSSS-LL functionality with only active-standby steering mode supported and depending on DNN configuration and UPF capability, the SMF encodes the “atsssCapab” attribute as one of MPTCP_ATSSS_LL_WITH_ASMODE_UL, MPTCP_ATSSS_LL_WITH_EXSDMODE_DL_ASMODE_UL, or MPTCP_ATSSS_LL_WITH_ASMODE_DLUL. If the UE is capable of MPTCP functionality with any steering mode and ATSSS-LL functionality with any steering mode allowed for ATSSS-LL supported and depending on DNN configuration, the SMF encodes the “atsssCapab” attribute as MPTCP_ATSSS_LL. If the UE is capable of MPQUIC functionality with any steering mode and ATSSS-LL functionality with only active-standby steering mode supported and depending on DNN configuration and UPF capability, the SMF encodes the “atsssCapab” attribute as one of MPQUIC_ATSSS_LL_WITH_ASMODE_UL, MPQUIC_ATSSS_LL_WITH_EXSDMODE_DL_ASMODE_UL, or MPQUIC_ATSSS_LL_WITH_ASMODE_DLUL. If the UE is capable of MPQUIC functionality with any steering mode and ATSSS-LL functionality with any steering mode allowed for ATSSS-LL supported and depending on DNN configuration, the SMF encodes the “atsssCapab” attribute as MPQUIC_ATSSS_LL. If the UE is capable of MPTCP functionality with any steering mode, MPQUIC functionality with any steering mode and ATSSS-LL functionality with only active-standby steering mode supported and depending on DNN configuration and UPF capability the SMF encodes the “atsssCapab” attribute as one of MPTCP_MPQUIC_ATSSS_LL_WITH_ASMODE_UL, MPTCP_MPQUIC_ATSSS_LL_WITH_EXSDMODE_DL_ASMODE_UL, or MPTCP_MPQUIC_ATSSS_LL_WITH_ASMODE_DLUL. If the UE is capable of MPTCP functionality with any steering mode, MPQUIC functionality with any steering mode and ATSSS-LL functionality with any steering mode allowed for ATSSS-LL supported and depending on DNN configuration, the SMF encodes the “atsssCapab” attribute as MPTCP_MPQUIC_ATSSS_LL.

An SMF may interpret a received ATSSS-ST encoding based on ATSSS steering functionalities supported by the SMF, which may, in turn, depend on whether the SMF is configured according to Release 17 or Release 18. The SMF generates the ATSSS capability information “atsssCapab” from the received ATSSS-ST encoding as summarized in Table 1 below.

TABLE 1
SMF generated ATSSS capability information

| ATSSS-ST | atsssCapab | Applicability |
|---|---|---|
| 0000 | NA | Release 17 and |
| | | release 18 |
| | | SMF |
| 0001 | ATSSS_LL | Release 17 and |
| | | release 18 |
| | | SMF |
| 0010 | MPTCP_ATSSS_LL_WITH_ASMODE_UL | Release 17 and |
| | MPTCP_ATSSS_LL_WITH_EXSDMODE_DL_ASMODE_UL | release 18 |
| | MPTCP_ATSSS_LL_WITH_ASMODE_DLUL | SMF |
| 0011 | MPTCP_ATSSS_LL | Release 17 and |
| | | release 18 |
| | | SMF |
| 0100 | MPQUIC_ATSSS_LL_WITH_ASMODE_UL | Release 18 |
| | MPQUIC_ATSSS_LL_WITH_EXSDMODE_DL_ASMODE_UL | SMF |
| | MPQUIC_ATSSS_LL_WITH_ASMODE_DLUL | |
| 0101 | MPQUIC_ATSSS_LL | Release 18 |
| | | SMF |
| 0110 | MPTCP_MPQUIC_ATSSS_LL_WITH_ASMODE_UL | Release 18 |
| | MPTCP_MPQUIC_ATSSS_LL_WITH_EXSDMODE_DL_ASM | SMF |
| | ODE_UL | |
| | MPTCP_MPQUIC_ATSSS_LL_WITH_ASMODE_DLUL | |
| 0110 | MPTCP_MPQUIC_ATSSS_LL | Release 18 |
| | | SMF |

As support for additional ATSSS steering functionalities is expanded from Release 17 to Release 18 and Release 19, compatibility issues may arise when establishing an MA PDU session between an SMF and a UE configured according to different releases. For example, an SMF configured according to Release 17 may be unable to understand an ATSSS-ST encoding that is not within {0000, 0001, 0011, 0100}, such as an ATSSS-ST encoding that corresponds to (e.g., indicates) any MPQUIC functionality. If a Release 18 UE indicates values other than {0000, 0001, 0011, 0100} for the ATSSS_ST encoding, the Release 17 SMF does not understand the encoding and is unable to create a corresponding “atsssCapab.” In Release 18, MPQUIC functionality is limited to MPQUIC-UDP, as Release 18 lacks support for MPQUIC-IP and MPQUIC-E functionalities introduced in Release 19. Thus, a UE configured according to Release 19 may support MPQUIC-UDP, MPQUIC-IP and MPQUIC-E, but an SMF configured according to Release 18 may be unable to differentiate between MPQUIC functionalities. In this example, the SMF may not understand a received ATSSS_ST encoding corresponding to MPQUIC-IP or MPQUIC-E and may be unable to create the corresponding “atsssCapab.” Alternatively, the SMF may incorrectly assume that any MPQUIC indication corresponds to MPQUIC-UDP, and may create an incorrect “atsssCapab” (e.g., corresponding to MPQUIC-UDP rather than MPQUIC-IP or MPQUIC-E).

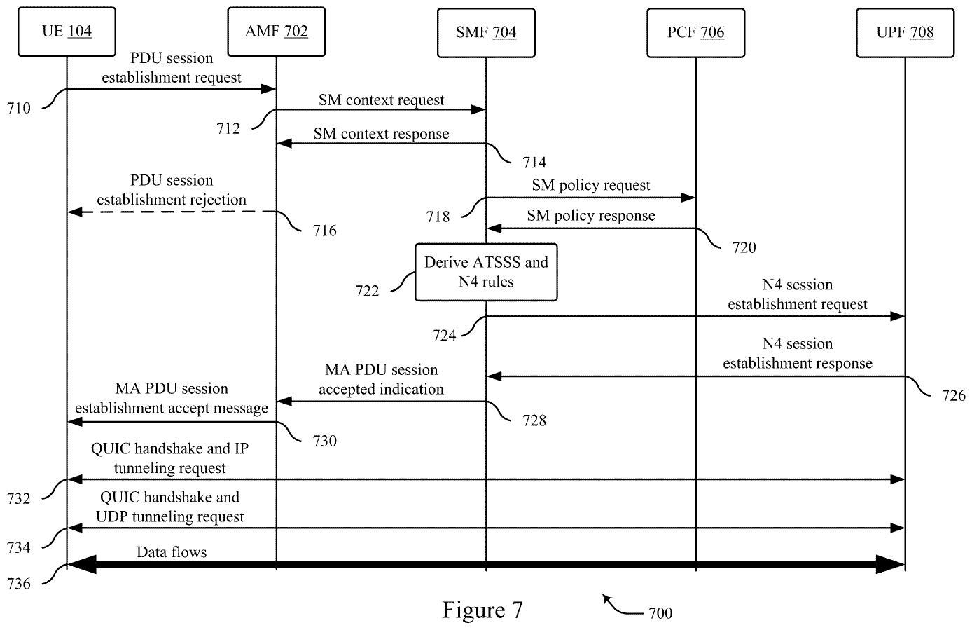

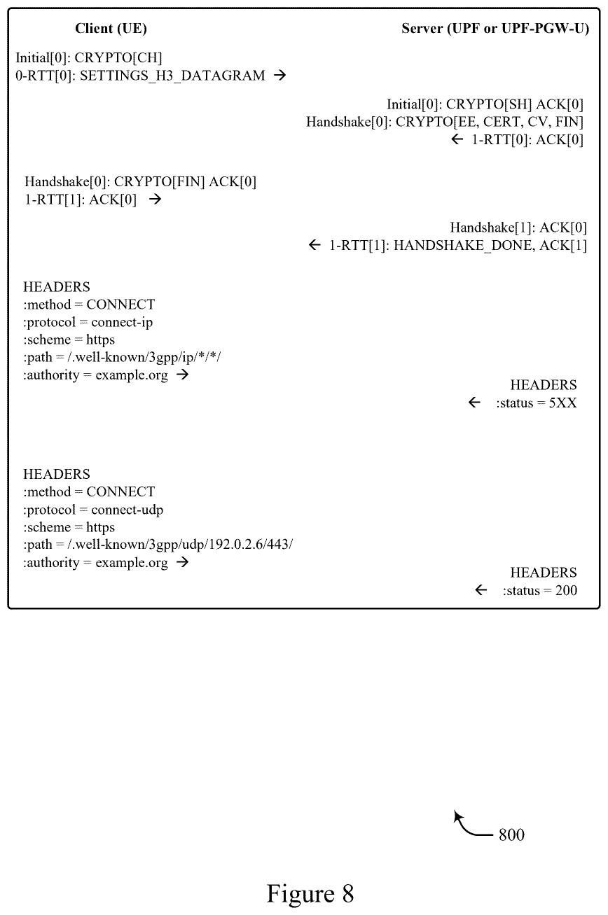

Consequently, the 5GSM capability information element field defined by Release 18 (e.g., or earlier releases) lacks values for indicating MPQUIC-IP and MPQUIC-E functionalities, and any indication of an MPQUIC functionality is assumed to correspond to MPQUIC-UDP. Accordingly, the techniques described herein provide for modifications to the 5GSM capability information element field to enable the UE to differentiate between MPQUIC-IP, MPQUIC-E, and MPQUIC-UDP functionalities in the request message. As such, a Release 19 SMF is able to create an appropriate “atsssCapab” for the MA PDU session. Additionally, as described with reference to FIGS. 6 and 7, the described techniques improve interoperability by providing for UE and SMF procedures implemented upon receipt of an ATSSS-ST encoding that the SMF does not support or is unable to interpret.

For example, a set of values 202-a may conventionally correspond to existing MPQUIC steering functionality indications defined in Table 9.11.4.1.1 of 3GPP TS 24.501 and Table 6.1.6.2-1 of 3GPP TS 24.193. According to the techniques described herein, this set of values 202-a is modified to correspond to the MPQUIC-UDP steering functionality indicating that the MPQUIC steering functionality is to be used in conjunction with establishing a UDP tunnel for UDP transmission. Additionally, a set of values 202-b is added to correspond to MPQUIC-IP and MPQUIC-E functionalities, indicating that the MPQUIC steering functionality is to be used in conjunction with establishing an IP tunnel for UDP data transmission and an Ethernet tunnel for UDP data transmission, respectively.

For instance, the set of values 202-a includes an MPQUIC-UDP functionality with any steering mode and ATSSS-LL functionality with only active-standby steering mode identified as 0100, an MPQUIC-UDP functionality with any steering mode and ATSSS-LL functionality with any steering mode allowed for ATSSS-LL identified as 0101, and so forth. The set of values 202-b includes an MPQUIC-IP functionality with any steering mode and ATSSS-LL functionality with only active-standby steering mode identified as 1000, an MPQUIC-IP functionality with any steering mode and ATSSS-LL functionality with any steering mode allowed for ATSSS-LL identified as 1001, and so forth.

A UE may include, in an MA PDU session request message, an ATSSS-ST encoding in accordance with FIG. 2 to indicate a requested ATSSS steering functionality and steering mode with improved granularity as compared to conventional techniques. An SMF receiving the request message interprets the ATSSS-ST encoding and responds to the UE based on whether the SMF is capable of supporting the requested ATSSS steering functionality and steering mode. For example, if the SMF supports the requested ATSSS steering functionality and steering mode, the SMF can communicate with a PCF and a UPF to establish the MA PDU session (e.g., in accordance with the requested ATSSS steering functionality and steering mode). The SMF communicates (e.g., transmits, sends), to the UE, a response message including an indication that the MA PDU session is accepted.

Alternatively, if the SMF is unable to interpret the ATSSS-ST encoding or lacks support for the requested ATSSS steering functionality and steering mode, the SMF can communicate (e.g., transmit, send), to the UE, a rejection message (e.g., a PDU session establishment reject message) indicating that the MA PDU session is rejected. For instance, if the SMF is a Release 17 SMF, the SMF may determine that the requested ATSSS steering functionality and steering mode is not supported if the ATSSS-ST encoding includes values outside of {0000, 0001, 0011, 0100}. The rejection message can include an error indication, such as an error cause value, that specifies that the requested ATSSS steering functionality and steering mode is not supported by the SMF. An error cause value (also referred to as a cause value, a code value, an error code, and the like) may be defined as an indication of a reason for rejecting the MA PDU session, and may be selected from a list (e.g., a predefined or preconfigured list, grouping, table, etc.) of error cause values (e.g., a 5GSM error cause value list, an EPS/EMS error cause value list). The error cause value may be a 5GSM cause value (e.g., if the SMF is a 5G SMF) included in an information element of the rejection message. For example, the SMF may set a value of a bit included as a 5GSM cause information element of the rejection message. Alternatively, the error cause value may be an ESM cause value (e.g., if the SMF is a 4G SMF) included in an evolved mobility management (EMM) cause information element of the rejection message. In some examples, the error cause value is dedicated to indicating lack of support for an ATSSS steering functionality and steering mode. In other examples, the error cause value is reused and/or is an existing error cause value (e.g., from Table 9.11.4.2.1 in 3GPP TS 24.501 or from Table 9.9.4.4.1 in 3GPP TS 24.301), such as “Protocol error, unspecified.”

In response to the rejection message, the UE may release the MA PDU session or may attempt to re-request establishment of the MAP PDU session. In the latter example, the UE can communicate (e.g., transmit, send) an additional request message that includes an ATSSS-ST encoding supported by the SMF. For instance, the UE may determine, based on the error cause value, that the SMF is a legacy SMF. The UE can indicate, in the additional request message, an ATSSS-ST encoding having values within {0000, 0001, 0011, 0100}.

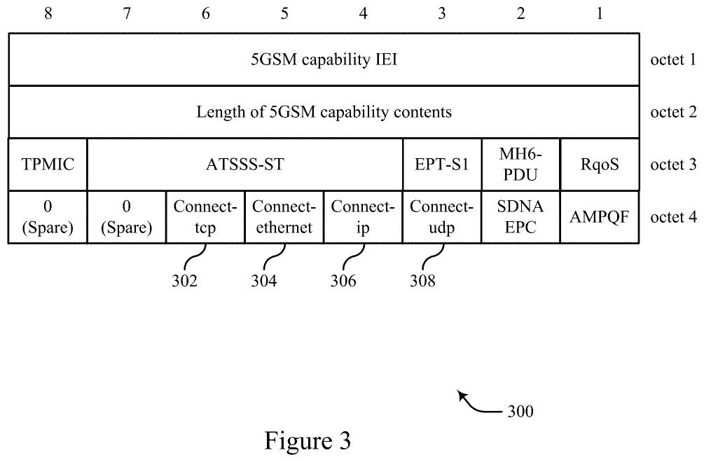

FIG. 3 illustrates an example 300 of a 5GSM capability information element in accordance with aspects of the present disclosure. The example 300 may implement or be implemented by aspects of the wireless communications system 100. For example, a UE (e.g., a UE 104) may indicate its ATSSS-ST capabilities to a network node (e.g., an NE 102, such as an AMF and/or an SMF) in accordance with the example 300 during establishment of an MA PDU session as described with reference to FIG. 1.

Conventionally, the 5GSM capability information element includes an information element field ATSSS-ST that carries an indication of at least one ATSSS steering functionality and steering mode supported and/or requested by the UE for the MA PDU session. In the example 300, the MPQUIC steering functionality is treated as an “umbrella” steering functionality, and information is added to the 5GSM capability information element to indicate a requested tunnel (e.g., tunnel type) to be established in conjunction with the MPQUIC steering functionality. A tunnel or tunnel type is also referred to herein as a connect protocol, connection type, or the like, and can include, but is not limited to, TCP, IP, Ethernet, or UDP. In addition to the ATSSS-ST field, the 5GSM capability information element includes at least one information element field indicating the connect protocol for the MA PDU session. The 5GSM capability information element also carries additional information (e.g., a transfer of port management information containers (TPMIC) bit indicating whether transfer of port management information containers is supported, an Ethernet PDN type in S1 (EPT-S1) bit indicating whether Ethernet PDN type in S1 mode is supported, an access performance measurements per quality of service (AMPQF) bit indicating whether access performance measurements per quality of service flow are supported, a reflective quality of service (RqoS) bit indicating whether reflective quality of service is supported, supported ATSSS steering functionalities, and so forth) beyond the connect protocol.

In contrast to the example 200 of FIG. 2, which includes discrete indications for each of MPQUIC-UDP, MPQUIC-IP, and MPQUIC-E, the example 300 includes a first indication corresponding to an ATSSS steering functionality (e.g., within the ASSS-ST field), such as ATSSS-LL, MPTCP, or MPQUIC, and a second indication corresponding to a tunnel, such as TCP, IP, Ethernet, or UDP, to be established in conjunction with the ATSSS steering functionality. That is, the ATSSS-ST field may include an ATSSS-ST encoding (e.g., a set of four bits having values corresponding to the requested ATSSS-ST steering functionality and steering mode), and an additional one or more information element fields may include a connect protocol indication.

In the example 300, the 5GSM capability information element includes four information element fields 302, 304, 306, and 308, where each field corresponds to a respective connect protocol (e.g., connect-tcp, connect-ethernet, connect-ip, and connect-udp, respectively). Each field may include at least one bit, where a value of the at least one bit indicates whether the UE supports and/or requests the corresponding connect protocol. As an example, a value of “1” may indicate that the corresponding connect protocol is supported or requested by the UE, while a value of “0” may indicate that the corresponding connect protocol is not supported or requested by the UE. In the example of FIG. 3, the at least one bit in the information element field 302 may be set to a value of “1” if TCP is the supported or requested connection type, the at least one bit in the information element field 304 may be set to a value of “1” if Ethernet is the supported or requested connection type, the at least one bit in the information element field 306 may be set to a value of “1” if IP is the supported or requested connection type, and/or the at least one bit in the information element field 308 may be set to a value of “1” if UDP is the supported or requested connection type. If no connection type is included in the 5GSM capability information element (e.g., if the at least one bits in the information element fields 302, 304, 306, and 308 are set to the value “0”), the supported connection type is assumed to be UDP.

A UE may include, in an MA PDU session request message, the 5GSM capability information element illustrated in the example 300 to indicate a requested ATSSS steering functionality and steering mode and a requested tunnel to be established in conjunction with the requested ATSSS steering functionality and steering mode. An SMF receiving the request message interprets the 5GSM capability information element and responds to the UE based on whether the SMF is capable of supporting the requested ATSSS steering functionality and steering mode and/or the requested connect protocol. For example, if the SMF supports the requested ATSSS steering functionality and steering mode and the requested connect protocol, the SMF can communicate with a PCF and a UPF to establish the MA PDU session (e.g., in accordance with the requested ATSSS steering functionality and steering mode and the requested connect protocol). The SMF communicates (e.g., transmits, sends), to the UE, a response message including an indication that the MA PDU session is accepted.

Alternatively, if the SMF is unable to interpret the ATSSS-ST encoding or lacks support for the requested ATSSS steering functionality and steering mode, the SMF can communicate (e.g., transmit, send), to the UE, a rejection message indicating that the MA PDU session is rejected. For instance, if the SMF is a Release 17 SMF, the SMF may ignore the information element fields 302, 304, 306, and 308, and may determine that the requested ATSSS steering functionality and steering mode is not supported if the ATSSS-ST encoding in the ATSSS-ST field includes values outside of {0000, 0001, 0011, 0100}. The rejection message can include an error indication, such as an error cause value, that specifies that the requested ATSSS steering functionality and steering mode is not supported by the SMF. The error cause value may be a 5GSM cause value or an ESM cause value. In some examples, the error cause value is dedicated to indicating lack of support for an ATSSS steering functionality and steering mode. In other examples, the error cause value is reused and/or is an existing error cause value (e.g., from Table 9.11.4.2.1 in 3GPP TS 24.501 or from Table 9.9.4.4.1 in 3GPP TS 24.301), such as “Protocol error, unspecified.”

In another example, the UE may indicate, in the 5GSM capability information element, a request for MPQUIC steering functionality (e.g., in the ATSSS-ST field) and a request for Ethernet tunneling or IP tunneling (e.g., in the information element fields 304 and 306, respectively). The SMF may be a Release 18 SMF that supports MPQUIC-UDP but does not support MPQUIC-IP or MPQUIC-E. In this example, and as described with reference to FIG. 7, the SMF may (mistakenly) interpret the request for MPQUIC steering functionality as a request for MPQUIC-UDP (e.g., based on the SMF's capability to support MPQUIC-UDP and lack of support for MPQUIC-IP and MPQUIC-E). The SMF may create and forward the attribute “atsssCapab” to a PCF, which generates PCC rules for MPQUIC-UDP. The PCF returns the PCC rules to the SMF, which derives and communicates (e.g., transmits, sends) corresponding ATSSS rules to the UE. Upon receipt of the ATSSS rules, the UE determines that the ATSSS rules are for MPQUIC-UDP, rather than the requested MPQUIC-IP or MPQUIC-E. Based on receiving the incorrect ATSSS rules, the UE determines or otherwise identifies that the SMF is a legacy SMF that does not support MPQUIC-IP or MPQUIC-E.

In response to a rejection message or incorrect ATSSS rules, the UE may release the MA PDU session or may attempt to re-request establishment of the MAP PDU session. In the latter example, the UE can communicate (e.g., transmit, send) an additional request message that includes an ATSSS-ST encoding supported by the SMF. For instance, the UE may determine, based on the error cause value and/or the incorrect ATSSS rules, that the SMF is a legacy SMF. The UE can indicate, in the additional request message, an ATSSS-ST encoding having values within {0000, 0001, 0011, 0100}.

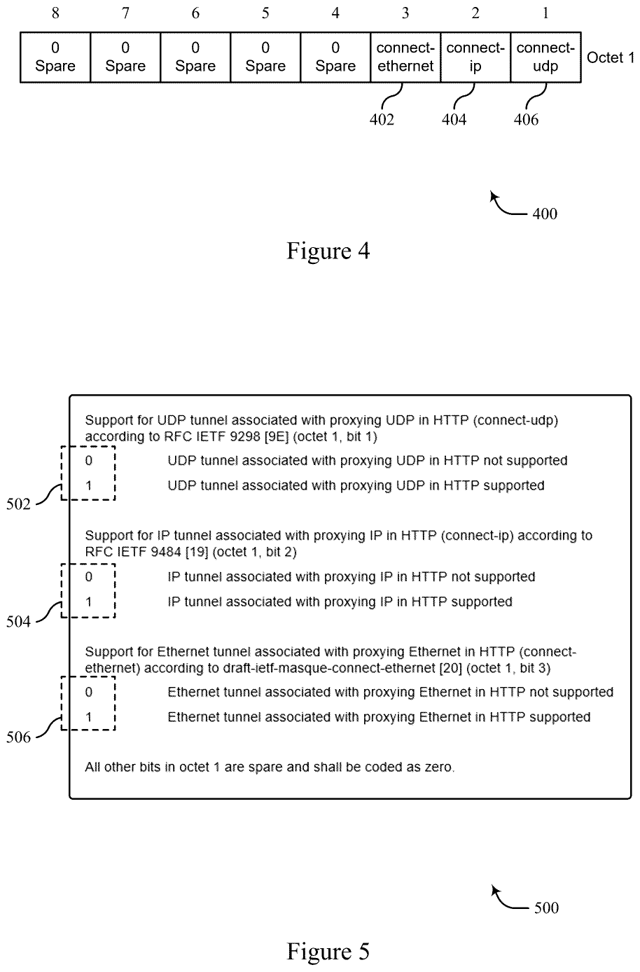

FIG. 4 illustrates an example 400 of tunneling indicator PCO parameter container contents in accordance with aspects of the present disclosure. The example 400 represents an ATSSS request for establishing an MA PDU session in an evolved packet system (EPS) network. For example, a UE (e.g., a UE 104) may indicate a requested connect protocol to a network node (e.g., an NE 102, such as an AMF and/or an SMF) in accordance with the example 400 during establishment of an MA PDU session as described with reference to FIG. 1. The SMF may include or be an example of an SMF plus packet data network gateway (PGW) control plane function (SMF+PGW-C) and may communicate with a UPF plus PGW user plane function (UPF+PGW-U).

During session establishment, the UE uses an ATSSS request PCO parameter to inform the SMF+PGW-C about the UE's ATSSS-ST capability and/or to request an ATSSS steering functionality and steering mode for the MA PDU session. The ATSSS request PCO parameter is listed in the ATSSS request PCO parameter container contents. Additionally, as described herein, the UE utilizes a tunneling indicator PCO parameter to indicate, to the SMF+PGW-C, a requested connect protocol (e.g., tunneling type) to be established in conjunction with the requested ATSSS steering functionality and steering mode. The tunneling indicator PCO parameter is listed in the tunneling indicator PCO parameter container contents, which may be associated with a container ID of tunneling indicator PCO parameter.

In the example 400, at least 3 bits of 8 total bits of octet 1 of the tunneling indicator PCO parameter container are used to indicate the preferred or supported connect protocol, while the remaining bits are spare and set to a value of 0. The tunneling indicator PCO parameter container includes a bit 402 corresponding to Ethernet (e.g., connect-ethernet), a bit 404 corresponding to IP (e.g., connect-IP), and a bit 406 corresponding to UDP (e.g., connect-UDP).

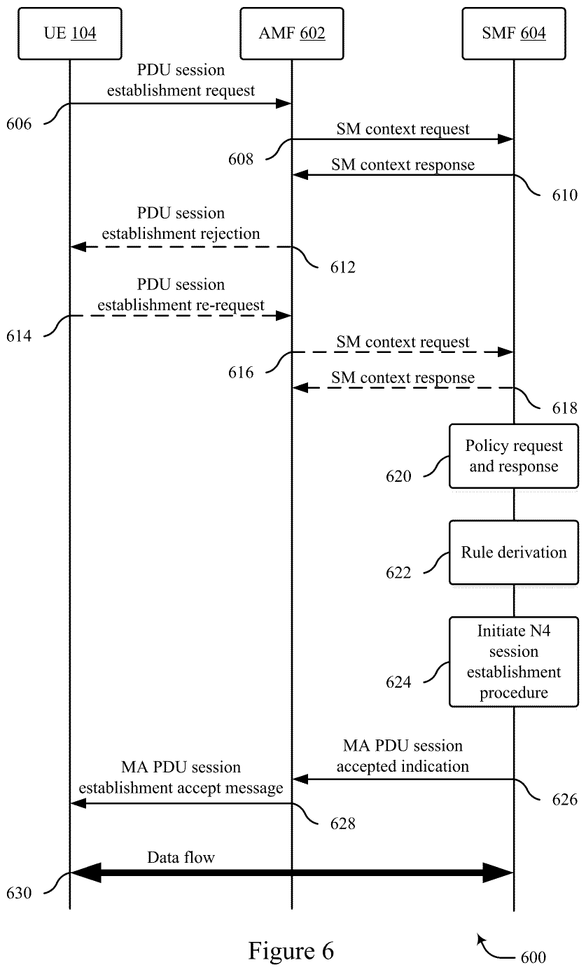

FIG. 5 illustrates an example 500 of tunneling indicator PCO parameter container contents in accordance with aspects of the present disclosure. In particular, the example 500 illustrates values 502, 504, and 506 of bits 402, 404, and 406, respectively, included in the tunneling indicator PCO parameter container to indicate one or more requested connect protocols for the MA PDU session. Each bit may be set to a value that indicates whether the UE supports and/or requests the corresponding connect protocol. For instance, a bit value of “1” may indicate that the UE supports and/or requests the corresponding connect protocol, while a bit value of “0” indicates that the UE does not support or request the corresponding connect protocol.

With three bits (e.g., the bits 402, 404, and 406) associated with indicating connect protocols, the connect protocol can be identified as 001 for connect-UDP, 010 for connect-ip, and 100 for connect-ethernet. In some examples, the UE may indicate support for multiple connect protocols. In such examples, the connect protocol can be identified as 011 for connect-udp and connect-ip, 101 for connect-udp and connect-ethernet, 110 for connect-ip and connect-ethernet, and 111 for connect-udp, connect-ip, and connect-ethernet. If all three bits are set to 0, the supported connect protocol is assumed to be connect-udp.

A UE may include, in an MA PDU session request message, the tunneling indicator PCO parameter container illustrated in the example 400 to indicate a requested tunnel to be established in conjunction with the requested ATSSS steering functionality and steering mode. An SMF receiving the request message responds to the UE based on whether the SMF is capable of supporting the requested ATSSS steering functionality and steering mode and/or the requested connect protocol. For example, if the SMF supports the requested ATSSS steering functionality and steering mode and the requested connect protocol, the SMF can communicate with a PCF and a UPF to establish the MA PDU session (e.g., in accordance with the requested ATSSS steering functionality and steering mode and the requested connect protocol). The SMF communicates (e.g., transmits, sends), to the UE, a response message including an indication that the MA PDU session is accepted.

Alternatively, if the SMF lacks support for the requested ATSSS steering functionality and steering mode and/or the requested connect protocol, the SMF can communicate (e.g., transmit, send), to the UE, a rejection message indicating that the MA PDU session is rejected. The rejection message can include an error indication, such as an error cause value, that specifies that the requested ATSSS steering functionality and steering mode is not supported by the SMF. The error cause value may be a 5GSM cause value or an ESM cause value. In some examples, the error cause value is dedicated to indicating lack of support for an ATSSS steering functionality and steering mode. In other examples, the error cause value is reused and/or is an existing error cause value (e.g., from Table 9.11.4.2.1 in 3GPP TS 24.501 or from Table 9.9.4.4.1 in 3GPP TS 24.301), such as “Protocol error, unspecified.”

In another example, if the SMF is a Release 18 SMF, the SMF may ignore the tunneling indicator PCO parameter container. In this example, and as described with reference to FIG. 7, the SMF may (mistakenly) interpret a request for MPQUIC steering functionality as a request for MPQUIC-UDP (e.g., based on the SMF's capability to support MPQUIC-UDP and lack of support for MPQUIC-IP and MPQUIC-E). The SMF may create and forward the attribute “atsssCapab” to a PCF, which generates PCC rules for MPQUIC-UDP. The PCF returns the PCC rules to the SMF, which derives and communicates (e.g., transmits, sends) corresponding ATSSS rules to the UE. Upon receipt of the ATSSS rules, the UE determines that the ATSSS rules are for MPQUIC-UDP, rather than the requested MPQUIC-IP or MPQUIC-E. Based on receiving the incorrect ATSSS rules, the UE determines or otherwise identifies that the SMF is a legacy SMF that does not support MPQUIC-IP or MPQUIC-E.

In response to a rejection message or incorrect ATSSS rules, the UE may release the MA PDU session or may attempt to re-request establishment of the MAP PDU session. In the latter example, the UE can communicate (e.g., transmit, send) an additional request message that includes an ATSSS-ST encoding supported by the SMF. For instance, the UE may determine, based on the error cause value and/or the incorrect ATSSS rules, that the SMF is a legacy SMF. The UE can indicate, in the additional request message, an ATSSS-ST encoding having values within {0000, 0001, 0011, 0100}.

FIG. 6 illustrates an example 600 of MA PDU session establishment in accordance with aspects of the present disclosure. In particular, FIG. 6 illustrates a UE-requested MA PDU session establishment between a UE 104 and a network, with the assumption that the UE 104 is already registered to the network. The example 600 illustrates the UE 104, an AMF 602, and an SMF 604, which may be include or examples of corresponding devices as described with reference to FIG. 1.

To establish a PDU session as the user plane resource of an MA PDU session, the UE 104 constructs a request message, such as an uplink (UL) non-access stratum (NAS) message for PDU session establishment procedures (e.g., a PDU session establishment request message), to send to a data network (DN) (e.g., a 5G DN). The request message can include an indication of a session type (e.g., an MA PDU session type) requested by the UE 104 and one or more information elements, including a 5GSM capability information element as described with reference to FIGS. 2 and 3. The 5GSM capability information element indicates (i.e., requests) at least one capability of the UE 104 for one or more supported ATSSS steering functionalities and steering modes. Additionally, connect protocol information can be included in the request message as described herein. Subsequent to the request message, the UE 104 receives a message based on the network's capability, or lack thereof, to support the indicated ATSSS steering functionality and steering mode. For example, if the network lacks support for the indicated ATSSS steering functionality and steering mode, the UE 104 may receive a rejection message indicating a cause value. Alternatively, if the network is capable of supporting the indicated ATSSS steering functionality and steering mode, the UE 104 can receive a session establishment accept message in response to the request message.

While the operations of the example 600 are illustrated in the context of a 5G network, it is to be understood that the techniques described herein are applicable to any type of network or combination of networks. For example, operations of the example 600 may be performed to establish an MA PDU session with an EPS network. The network nodes may include or be examples of 4G network nodes. The SMF 604 may include or be an example of an SMF+PGW-C and may communicate with a UPF+PGW-U. In such examples, the request message may include one or more PCO parameters, such as described with reference to FIGS. 4 and 5.

At 606, the UE 104 initiates (e.g., communicates, transmits, sends) the request message to the AMF 602. The session establishment request at 610 notifies the CN 106 (e.g., the AMF 602) that the UE 104 is requesting to establish an MA PDU session.

At 608, the AMF 602 determines an SMF 604 to create a session management (SM) context based on the request message received from the UE 104. For instance, the AMF 602 can select an SMF 604 that supports the requested ATSSS steering functionalities and steering modes and, if applicable, the requested connect protocol. Upon determining the SMF 604, the AMF 602 constructs and communicates (e.g., transmits, sends) to the SMF 604 a request to generate an SM context. The request to generate the SM context is, for example, an Nsmf_PDUSession_CreateSMContext request that includes information related to the requested ATSSS steering functionalities and steering modes and, if applicable, the requested connect protocol. The request to generate the SM context provides the SMF 604 with the appropriate data, information, etc. to establish a SM context for the requested MA PDU session.

At 610, an SM context is created by the SMF 604 according to the requested ATSSS steering functionalities and steering modes. Upon creating the SM context, the SMF 604 informs the AMF 602 of the SM context ID for the created SM context via an SM context response. For example, the SMF 604 communicates (e.g., transmits, sends) a Nsmf_PDUSession_CreateSMContext response to provide the SM context ID. The SM context ID provides addressing information allocated by the SMF 604 (e.g., to be used for service operations towards the SMF 604 for the requested MA PDU session).

In some examples, at 610, the SMF 604 may determine or otherwise identify that it lacks support for the requested ATSSS steering functionality and steering mode. For instance, the SMF 604 may not recognize or otherwise be capable of interpreting the indication of the ATSSS steering functionality and steering mode in the request message, and may therefore determine that the ATSSS steering functionality and steering mode is not supported. In such examples, instead of creating the SM context, the SMF 604 rejects the request and, at 610, communicates (e.g., transmits, sends), to the AMF 602, a PDU session establishment rejection message in response to the request message. At 612, the AMF 602 communicates (e.g., transmits, sends) the rejection message to the UE 104. The rejection message may include an indication of an error cause value (e.g., a 5GSM cause value, an ESM cause value) indicating that the requested ATSSS steering functionality and steering mode is not supported.

In some examples, at 612, the UE 104 releases the MA PDU session and/or refrains from attempting to establish the MA PDU session with the network based on receiving the rejection message. Alternatively, at 614, the UE 104 can re-request establishment of the MA PDU session by communicating (e.g., transmitting, sending) an additional request message to the AMF 602. In this scenario, reception of the error cause value triggers the UE 104 to detect or otherwise identify that the network is a legacy network and is thus incapable of supporting the originally-requested ATSSS steering functionality and steering mode (and, in some cases, the originally-requested connect protocol). Based on the error cause value, the UE 104 indicates, in the additional request message, a request for an ATSSS steering functionality and steering mode supported by legacy networks (e.g., ATSSS-LL, MPTCP, MPQUIC-UDP), which may be different from the originally-requested ATSSS steering functionality and steering mode. In some examples, the UE 104 may refrain from separately indicating a connect protocol (e.g., as described with reference to FIGS. 3-5) in the additional request message based on receiving the error cause value.

At 616, based on receiving the additional request message, the AMF 602 constructs and communicates (e.g., transmits, sends), to the SMF 604, an additional request to generate an SM context. The additional request to generate the SM context is, for example, an Nsmf_PDUSession_CreateSMContext request that includes information related to the ATSSS steering functionality and steering mode indicated in the additional request message.

At 618, an SM context is created by the SMF 604 according to the ATSSS steering functionality and steering mode indicated in the additional request message. Upon creating the SM context, the SMF 604 informs the AMF 602 of the SM context ID for the created SM context via an SM context response. For example, the SMF 604 communicates (e.g., transmits, sends) a Nsmf_PDUSession_CreateSMContext response to provide the SM context ID. The SM context ID provides addressing information allocated by the SMF 604 (e.g., to be used for service operations towards the SMF 604 for the requested MA PDU session).

At 620, the SMF 604 requests policy information from a PCF for the requested MA PDU session. For example, the SMF 604 requests the PCF to establish an SM Policy Association by transmitting information about the PDU session by communicating (e.g., transmitting, sending), an Npcf_SMPolicyControl_Create to the PCF. This provides the PCF with the appropriate data, information, etc. to determine the appropriate policy for the requested MA PDU session. The PCF communicates (e.g., transmits, sends) a response to the SMF 604 that includes SMF policy information as policy and charging control (PCC) rules, for example, via an Npcf_SMPolicyControl_Create response. The PCC rules align with the ATSSS steering functionality and steering mode indicated in the additional request message and include steering functionality, transport mode, and connection type (connect-udp, connect-ip, connect-ethernet and/or connect-tcp) and parameters associated with the connection type. This notifies the SMF 604 of the appropriate policy to apply for the requested MA PDU session.

At 622, the SMF 604 derives (e.g., generates) rules for the requested PDU session based on the PCC rules received from the PCF. For example, the SMF 604 derives, from the received PCC rules, (a) ATSSS rules, which will be sent to the UE 104 for controlling the traffic steering, switching and splitting in the uplink direction and (b) N4 rules, which will be sent to the UPF for controlling the traffic steering, switching and splitting in the downlink direction. The ATSSS rules and the N4 rules align with the ATSSS steering functionality and steering mode indicated in the additional request message.

At 624, the SMF 604 communicates (e.g., transmits, sends) a session establishment request to a UPF. For example, the SMF 604 initiates an N4 session establishment procedure with the UPF by sending N4 rules derived by the SMF 604 (e.g., at 622) for the requested MA PDU session, which to instruct the UPF to activate the indicated ATSSS steering functionality for this MA PDU session. This allows the UPF to activate the ATSSS steering functionality for the requested MA PDU session. The UPF communicates (e.g., transmits, sends), to the SMF 604, a response to the N4 session establishment request. For example, the UPF allocates addresses/prefixes to the UE 104 and sends the addresses/prefixes and proxy information to the SMF 604. The SMF 604 returns the address/prefixes and proxy information to the UE 104.

At 626, the SMF 604 communicates (e.g., transmits, sends), to the AMF 602 in response to the request message, an indication that the requested MA PDU session has been accepted. For example, the SMF 604 includes an “MA PDU session Accepted” indication in the Namf_Communication_NIN2MessageTransfer message to the AMF 602 and indicates to the AMF that the N2 SM Information included in this message should be sent to the UE 104. The AMF marks this PDU session as an MA PDU session based on the received “MA PDU session Accepted” indication. This allows the AMF 602 to notify the UE 104 that the requested MA PDU session has been accepted by the network.

At 628, the AMF 602 communicates (e.g., transmits, sends) the response message to the UE 104, which includes an indication that the requested MA PDU session has been accepted. For example, the UE 104 receives a PDU session establishment accept message from the AMF 602, which indicates to UE 104 that the requested MA PDU session was successfully established. This message includes the ATSSS rules for the MA PDU session, which were derived by the SMF 604 based on the addresses/prefixes of the UE 104 and the MPQUIC proxy information. This provides the UE 104 with the information and rules to use to for data flow(s) associated with the MA PDU session. The ATSSS rules align with the ATSSS steering functionality and steering mode indicated in the additional request message.

At 630, uplink and downlink data flows are established for the requested MA PDU session. The UE 104 follows the ATSSS rules to establish the data flows.

FIG. 7 illustrates an example 700 of MA PDU session establishment in accordance with aspects of the present disclosure. In particular, FIG. 7 illustrates a procedure for UE-requested MA PDU session establishment between a UE 104 and a network, where the UE 104 requests (e.g., via a request message) an ATSSS steering functionality and steering mode for the MA PDU session as described herein. The example 700 illustrates a UE 104, an AMF 702, an SMF 704, a PCF 706, and a UPF 708, which may be include or examples of corresponding devices as described with reference to FIG. 1.

To establish a PDU session as the user plane resource of an MA PDU session, the UE 104 constructs a request message, such as an UL NAS message for PDU session establishment procedures (e.g., a PDU session establishment request message), to send to a DN. The request message can include an indication of a session type (e.g., an MA PDU session type) requested by the UE 104 and one or more information elements, including a 5GSM capability information element as described with reference to FIGS. 2 and 3. The 5GSM capability information element indicates at least one capability of the UE 104 for one or more supported ATSSS steering functionalities and one or more supported ATSSS steering modes. Additionally, connect protocol information can be included in the request message as described herein.

In the example 700, it is assumed that the UE 104 is already registered to the network. Further, it is assumed that the ATSSS steering functionality and steering mode requested by the UE 104 is not supported by the network. That is, FIG. 7 illustrates an example in which the network misunderstands (e.g., misinterprets) an ATSSS steering functionality and steering mode encoding included in the request message. This scenario may occur if the network is a legacy network (e.g., a Release 18 network) that lacks support for MPQUIC as an “umbrella” steering functionality (e.g., as described with reference to FIGS. 3-5). For example, the UE 104 may be a Release 19 UE that includes, in the request message, a first indication requesting MPQUIC functionality and a second indication (e.g., a separate indication) requesting a connect protocol (e.g., UDP tunneling, IP tunneling, Ethernet tunneling) to be used in conjunction with the MPQUIC functionality. Because the network is a legacy network, the network may be unable to interpret—and thus may ignore—the second indication. Instead, the network may assume, based on the first indication alone, that the UE 104 is requesting MPQUIC-UDP functionality (e.g., MPQUIC functionality to be used in conjunction with UDP tunneling). Thus, if the UE 104 indicated a connect protocol other than UDP (e.g., IP, Ethernet), the rules and parameters established by the network may not be appropriate for the MA PDU session.

While the operations of the example 700 are illustrated in the context of a 5G network, it is to be understood that the techniques described herein are applicable to any type of network or combination of networks. For example, operations of the example 700 may be performed to establish an MA PDU session with a 4G network. The network nodes may include or be examples of 4G network nodes. The SMF 704 may include or be an example of an SMF+PGW-C and the UPF 708 may include or be an example of a UPF+PGW-U. In such examples, the request message may include one or more PCO parameters, such as described with reference to FIGS. 4 and 5.

At 710, the UE 104 initiates (e.g., communicates, transmits, sends) the request message to the AMF 702. The session establishment request at 710 notifies the CN 106 (e.g., the AMF 702) that the UE 104 is requesting to establish an MA PDU session. In the example 700, the request message includes a 5GSM capability information element as described with reference to FIG. 3. The 5GSM capability information element may include at least a first indication of a supported ATSSS steering functionality and steering mode (e.g., MPQUIC) requested by the UE 104 and a second indication of a supported connect protocol (e.g., IP tunneling) requested by the UE 104 for use in conjunction with the supported ATSSS steering functionality and steering mode.

At 712, the AMF 702 determines an SMF 704 to create an SM context based on the request message received from the UE 104. Upon determining the SMF 704, the AMF 702 constructs and communicates (e.g., transmits, sends), to the SMF 704, a request to generate the SM context. The request to generate the SM context is, for example, an Nsmf_PDUSession_CreateSMContext request with information elements to create an SM context. The request to generate the SM context provides the SMF 704 with the appropriate data, information, etc. to establish the SM context for the requested MA PDU session.

In some examples, at 712, the SMF 704 may alternatively determine or otherwise identify that it lacks support for the requested ATSSS steering functionality and steering mode. For instance, the SMF 704 may not recognize or otherwise be capable of interpreting the indication of the ATSSS steering functionality and steering mode in the request message, and may therefore determine that the ATSSS steering functionality and steering mode is not supported. In such examples, instead of creating the SM context, the SMF 704 rejects the request and, at 714, communicates (e.g., transmits, sends), to the AMF 702, a PDU session establishment rejection message in response to the request message. At 716, the AMF 702 communicates (e.g., transmits, sends) the rejection message to the UE 104. The rejection message may include an indication of a cause value (e.g., a 5GSM cause value, an ESM cause value) indicating that the requested ATSSS steering functionality and steering mode is not supported. The UE 104 may refrain from attempting to establish the MA PDU session with the network based on receiving the rejection message, and the establishment procedure ends.

Alternatively, at 714, the SMF 704 mistakenly assumes that it supports the requested ATSSS steering functionality and steering mode and creates the SM context. Upon creating the SM context, the SMF 704 informs the AMF 702 of the SM context ID for the created SM context. For example, the SMF 704 communicates (e.g., transmits, sends), to the AMF 702, a Nsmf_PDUSession_CreateSMContext response to provide the SM context ID. The SM context ID provides addressing information allocated by the SMF 704 (e.g., to be used for service operations towards the SMF 704 for the requested MA PDU session).

At 718, the SMF 704 requests policy information for the requested MA PDU session.

For example, the SMF 704 requests the PCF 706 to establish an SM Policy Association by transmitting the information about the PDU session by communicating (e.g., transmitting, sending), an Npcf_SMPolicyControl_Create message. This provides the PCF 706 with the appropriate data, information, etc. to determine the appropriate policy for the requested MA PDU session.

At 720, the PCF 706 communicates (e.g., transmits, sends) a response to the SMF 704. For example, the PCF 706 provides, to the SMF 704, the SMF policy information as policy and charging control (PCC) rules via a Npcf_SMPolicyControl_Create response. The PCC rules include MPQUIC steering functionality, transport mode, and connection type (e.g., IP), as well as parameters associated with the connection type. This notifies the SMF 704 of the appropriate policy to apply for the requested MA PDU session.

At 722, rules for the requested PDU session are generated (e.g., derived) by the SMF 704. For example, the SMF 704 derives, from the received PCC rules, (a) ATSSS rules, which will be sent to the UE 104 for controlling the traffic steering, switching, and splitting in the uplink direction, and (b) N4 rules, which will be sent to the UPF 708 for controlling the traffic steering, switching, and splitting in the downlink direction. When the requested ATSSS steering functionality and steering mode are supported by the network, the ATSSS rules correspond to the requested ATSSS steering functionality and steering mode. In this example, however, due to the misinterpretation of the request, the SMF 704 generates ATSSS rules for MPQUIC-UDP (e.g., instead of MPQUIC-IP as requested by the UE 104).

At 724, the SMF 704 communicates (e.g., transmits, sends) a session establishment request to the UPF 708. For example, the SMF 704 initiates an N4 Session establishment procedure with the UPF 708 by sending the N4 rules derived by the SMF 704 (e.g., at 722) for the requested MA PDU session to instruct the UPF 708 to activate the MPQUIC functionality for this MA PDU session. This allows the UPF 708 to activate the MPQUIC functionality for the requested MA PDU session.

At 726, the UPF 708 communicates (e.g., transmits, sends) to the SMF 704 a response to the session establishment request. For example, the UPF 708 allocates the UE 104 “MPQUIC link-specific multipath” addresses/prefixes and sends the “MPQUIC link-specific multipath” addresses/prefixes and MPQUIC proxy information to the SMF 704. This allows the “MPQUIC link-specific multipath” addresses/prefixes and MPQUIC proxy information to be returned to the UE 104.

At 728, the SMF 704 communicates (e.g., transmits, sends) to the AMF 702 an indication that the requested MA PDU session has been accepted. For example, the SMF 704 includes an “MA PDU session Accepted” indication in a Namf_Communication_N1N2MessageTransfer message to the AMF 702 and indicates to the AMF 702 that N2 SM Information included in this message should be sent to the UE 104 as a response to the request message. The AMF 702 marks this PDU session as an MA PDU session based on the received “MA PDU session Accepted” indication. This allows the AMF 702 to notify the UE 104 that the requested MA PDU session has been accepted by the network.

At 730, the AMF 702 communicates (e.g., transmits, sends) the response message to the UE 104, which is an indication that the requested MA PDU session has been accepted. For example, the UE 104 receives a PDU session establishment accept message, which indicates to UE 104 that the requested MA PDU session was successfully established. This message includes the ATSSS rules for the MA PDU session, which were derived by the SMF 704 at 722, and the “MPQUIC link-specific multipath” addresses/prefixes of the UE 104 and the MPQUIC proxy information. This provides the UE 104 with the information and rules to use to for data flows of the MA PDU session.

In some examples, at 730, the UE 104 can identify that the received ATSSS rules are for an ATSSS steering functionality different from that requested by the UE 104 at 710. For instance, the UE 104 may detect that the ATSSS rules correspond to MPQUIC-UDP (e.g., as supported by the network according to Release 18), rather than MPQUIC-IP as requested by the UE 104. In response, the UE 104 may release the MA PDU session and the procedure may end. Additionally, or alternatively, the UE 104 may attempt to request an MA PDU session establishment from a different network that may support MPQUIC-IP.

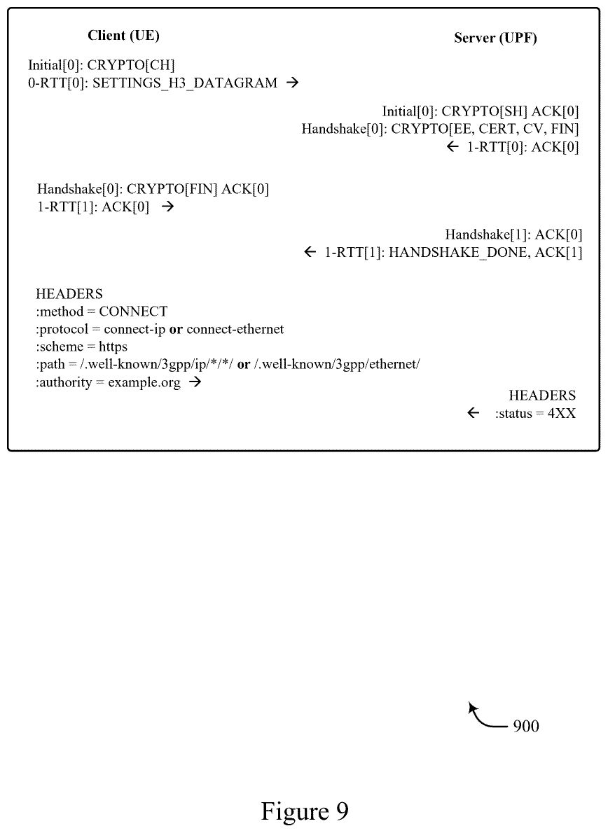

Additionally, or alternatively, the UE 104 may not recognize that the ATSSS rules are for MPQUIC-UDP and/or may attempt to complete the MA PDU session establishment. In such examples, at 732, the UE 104 initiates a QUIC handshake with the UPF 708 to establish a QUIC connection. The UE 104 additionally requests a tunnel establishment according to the requested IP connect protocol by inserting an indication of the IP connect protocol type in a: protocol header of a CONNECT method message, as described below with reference to FIG. 8. Upon receipt of the CONNECT method message, the UPF 708 determines or otherwise identifies that the UPF 708 lacks support for IP tunneling. Accordingly, the UPF 708 responds with a status code (e.g., a 5XX status code, such as 501) indicating that the requested tunneling is not implemented (e.g., by the UPF 708).

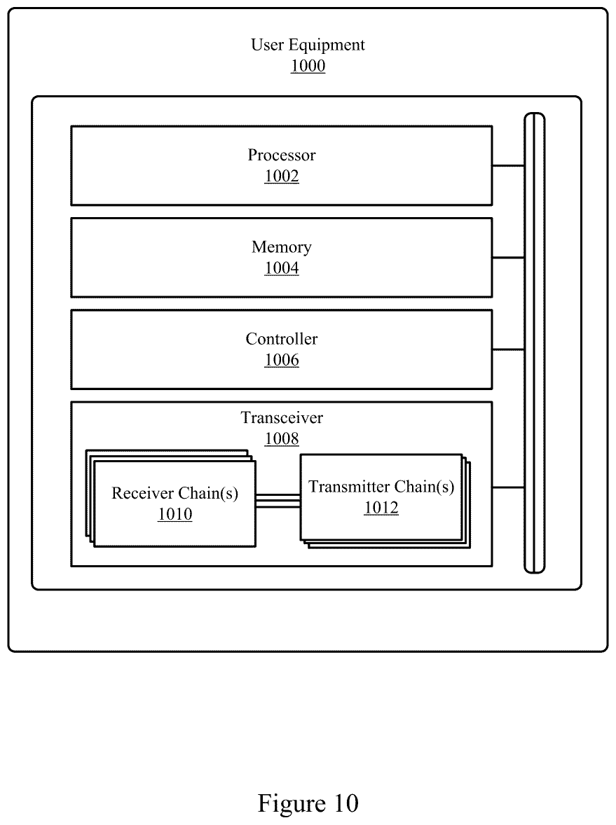

Based on receiving the status code, the UE 104 determines or otherwise identifies that the network does not support the requested IP tunneling. Thus, the UE 104 further determines that the network is a legacy network and has misinterpreted the MPQUIC request as a request for MPQUIC-UDP (e.g., in accordance with Release 18). In some examples, the UE 104 may consequently release the MA PDU session. Alternatively, at 734, the UE 104 may opt to establish the MA PDU session according to the network's capabilities. The UE 104 may therefore initiate an additional QUIC handshake with the UPF 708 to establish the QUIC connection using UDP tunneling. In this example, the UE 104 inserts an indication of the UDP connect protocol type in a: protocol header of a CONNECT method message, as described below with reference to FIG. 9. The UPF 708 responds with an accept indication, which may include a status code (e.g., 200) indicating that the requested tunneling is accepted.

At 736, the uplink and downlink data flows are established for the requested MA PDU session. The UE 104 follows the ATSSS rules to establish the data flows. According to the ATSSS rules, the UE 104 is to use the MPQUIC steering functionality in conjunction with UDP tunneling.

FIG. 8 illustrates example 800 of a QUIC handshake and tunneling request in accordance with aspects of the present disclosure. In particular, the example 800 illustrates signaling exchanged between the UE 104 and the UPF 708 as described with reference to FIG. 7. The UE 104 initiates the QUIC handshake with the UPF 708 when attempting to establish the QUIC connection using IP tunneling. The UE 104 requests to use an IP connect protocol (e.g., connection type) by inserting an indication (e.g., “connect-ip”) into the: protocol header of the CONNECT method message. Because the UPF 708 does not support MPQUIC-IP, the UPF 708 responds to the UE 104 with a status code (e.g., a 5XX status code, such as 501) indicating that the requested tunneling is not implemented.

Based on receiving the status code indicating that the requested tunneling is not implemented, the UE 104 attempts to re-establish the MA PDU session according to a connect protocol and tunneling type supported by the UPF 708. The UE 104 determines, based on the UPF 708 not implementing the IP tunneling, that the UPF 708 is a Release 18 UPF that supports MPQUIC-UDP. Accordingly, the UE 104 requests establishment of a UDP tunnel for the QUIC connection by inserting “connect-udp” into the “protocol header” of a subsequent CONNECT method message communicated (e.g., transmitted, sent) to the UPF 708. In response, the UPF 708 communicates (e.g., transmits, sends) a status code (e.g., 200) indicating that the requested UDP tunneling is accepted and implemented for the QUIC connection.

FIG. 9 illustrates example 900 of a QUIC handshake and tunneling request in accordance with aspects of the present disclosure. In particular, the example 900 illustrates signaling exchanged between the UE 104 and the UPF 708 as described with reference to FIG. 7. In this example, the SMF 704 may be a Release 18 SMF and the UE 104 may be a Release 19 UE that has requested MPQUIC steering functionality in conjunction with IP tunneling or Ethernet tunneling for the MA PDU session. Because the SMF 704 is configured according to Release 18, the SMF 704 interprets the request as being for an MA PDU session with MPQUIC steering functionality as defined according to Release 18, in which MPQUIC steering functionality is limited to UDP tunneling. Subsequent to receiving the request from the UE 104, the SMF 704 requests and receives, from the PCF 706, PCC rules associated with MPQUIC-UDP. The SMF 704 derives, using the PCC rules, ATSSS rules for the UE 104 and N4 rules for the UPF 708. The SMF 704 communicates (e.g., transmits, sends) the ATSSS rules to the UE 104 and the N4 rules to the UPF 708. Upon receipt of the ATSSS rules, the UE 104 determines or otherwise identifies that the ATSSS rules are for MPQUIC-UDP (e.g., rather than MPQUIC-IP or MPQUIC-E, as requested by the UE 104). Based on this determination, the UE 104 can release the MA PDU session.

Alternatively, if the UE 104 does not release the MA PDU session, the UE 104 may initiate the QUIC handshake with the UPF 708 when attempting to establish the QUIC connection (e.g., a data connection) with the UPF 708. The UE 104 requests to use an IP connect protocol or an Ethernet connect protocol by inserting an indication (e.g., “connect-ip” or “connect-ethernet,” respectively) into the: protocol header of the CONNECT method message. Because the UPF 708 has received N4 rules associated with MPQUIC-UDP, the UPF 708 can reject the data connection requested by the UE 104. The UPF 708 responds to the UE 104 with a status code (e.g., a 4XX status code) indicating that the requested IP or Ethernet tunneling is not allowed. Based on receiving the status code, the UE 104 can release or otherwise terminate the MA PDU session.

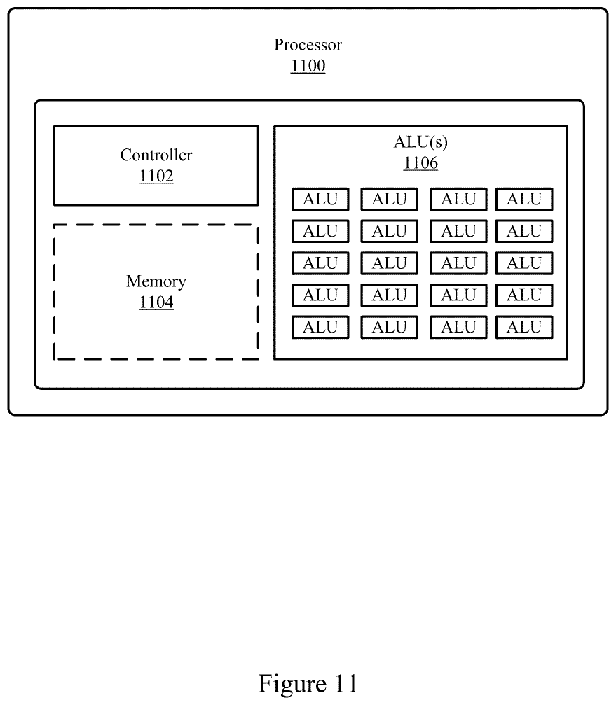

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for transmitting, to an NE, a request message to establish an MA PDU session, where the request message includes an indication of an ATSSS steering functionality and steering mode for the MA PDU session, and receiving, from the NE, a response message based on the request message, where the response message is associated with whether the NE is capable of supporting the ATSSS steering functionality and steering mode.

Additionally, the UE 1000 may be operable to support any one or combination of the response message includes a cause value indicating a rejection of the MA PDU session based on the NE lacking a capability to support the ATSSS steering functionality and steering mode. Additionally, or alternatively, the cause value includes a 5GSM cause value or an ESM cause value. Additionally, or alternatively, the method further comprises transmitting, to the NE, a subsequent request message to establish the MA PDU session, where the subsequent request message includes an indication of an alternative ATSSS steering functionality and steering mode for the MA PDU session based on the NE being capable of supporting the alternative ATSSS steering functionality and steering mode.

Additionally, or alternatively, the method further comprises refraining from establishing the MA PDU session based on the cause value. Additionally, or alternatively, the ATSSS steering functionality and steering mode includes at least one of an MPQUIC-IP functionality, an MPQUIC-E functionality, or an MPQUIC-UDP functionality, and the indication is included in an ATSSS steering functionality and steering mode information element field of a 5GSM capability information element. Additionally, or alternatively, the ATSSS steering functionality and steering mode includes an MPQUIC functionality, the indication is included in a 5GSM capability information element, and the 5GSM capability information element includes an indication of a connect protocol for the MA PDU session. Additionally, or alternatively, the ATSSS steering functionality and steering mode includes an MPQUIC functionality, the indication is included as an ATSSS request PCO parameter, and the request message further includes a tunneling indicator PCO parameter that indicates a connect protocol for the MA PDU session.

Additionally, or alternatively, the response message includes an additional tunneling indicator PCO parameter that indicates an acknowledgement of the connect protocol, the tunneling indicator PCO parameter and the additional tunneling indicator PCO parameter share a same container identifier, and the method further comprises establishing the MA PDU session according to the connect protocol based on receiving the response message. Additionally, or alternatively, the ATSSS steering functionality and steering mode includes at least one of an MPQUIC-IP functionality or an MPQUIC-E functionality, and the response message includes one or more rules associated with an alternative ATSSS steering functionality and steering mode that includes an MPQUIC-UDP functionality.

Additionally, or alternatively, the method further comprises transmitting, to the NE, a subsequent request message to establish the MA PDU session, where the subsequent request message includes an indication of the alternative ATSSS steering functionality and steering mode based on the NE being capable of supporting the alternative ATSSS steering functionality and steering mode. Additionally, or alternatively, the method further comprises refraining from establishing the MA PDU session based on the response message including the one or more rules associated with the alternative ATSSS steering functionality and steering mode. Additionally, or alternatively, the method further comprises transmitting, to an additional NE, a tunnel establishment request message that indicates a connect protocol for the MA PDU session, where the connect protocol includes at least one of an IP or an Ethernet protocol. Additionally, or alternatively, the method further comprises establishing the MA PDU session in accordance with the connect protocol and the ATSSS steering functionality and steering mode. Additionally, or alternatively, the method further comprises receiving, from the additional NE, an indication that the connect protocol is not allowed based on the message including the one or more rules associated with the alternative ATSSS steering functionality and steering mode.

Additionally, or alternatively, the UE 1000 may support at least one memory (e.g., the memory 1004) and at least one processor (e.g., the processor 1002) coupled with the at least one memory and operable to cause the UE 1000 to transmit, to an NE, a request message to establish an MA PDU session, where the request message includes an indication of an ATSSS steering functionality and steering mode for the MA PDU session, and receive, from the NE, a response message based on the request message, where the response message is associated with whether the NE is capable of supporting the ATSSS steering functionality and steering mode.

Additionally, the UE 1000 may be operable to support any one or combination of the response message includes a cause value indicating a rejection of the MA PDU session. Additionally, or alternatively, the cause value includes a 5GSM cause value or an ESM cause value. Additionally, or alternatively, the at least one processor is operable to cause the UE 1000 to transmit, to the NE, a subsequent request message to establish the MA PDU session, where the subsequent request message includes an indication of an alternative ATSSS steering functionality and steering mode for the MA PDU session based on the NE being capable of supporting the alternative ATSSS steering functionality and steering mode. Additionally, or alternatively, the at least one processor is operable to cause the UE 1000 to refrain from establishing the MA PDU session based on the cause value. Additionally, or alternatively, the ATSSS steering functionality and steering mode includes at least one of an MPQUIC-IP functionality, an MPQUIC-E functionality, or an MPQUIC-UDP functionality, and the indication is included in an ATSSS steering functionality and steering mode information element field of a 5GSM capability information element.

Additionally, or alternatively, the ATSSS steering functionality and steering mode includes an MPQUIC functionality, the indication is included in a 5GSM capability information element, and the 5GSM capability information element includes an indication of a connect protocol for the MA PDU session. Additionally, or alternatively, the ATSSS steering functionality and steering mode includes an MPQUIC functionality, the indication is included as an ATSSS request PCO parameter, and the request message further includes a tunneling indicator PCO parameter that indicates a connect protocol for the MA PDU session. Additionally, or alternatively, the response message includes an additional tunneling indicator PCO parameter that indicates an acknowledgement of the connect protocol, the tunneling indicator PCO parameter and the additional tunneling indicator PCO parameter share a same container identifier, and the at least one processor is operable to cause the UE 1000 to establish the MA PDU session according to the connect protocol based on receiving the response message. Additionally, or alternatively, the ATSSS steering functionality and steering mode includes at least one of an MPQUIC-IP functionality or an MPQUIC-E functionality, and the response message includes one or more rules associated with an alternative ATSSS steering functionality and steering mode that includes an MPQUIC-UDP functionality.

Additionally, or alternatively, the at least one processor is operable to cause the UE 1000 to transmit, to the NE, a subsequent request message to establish the MA PDU session, and the subsequent request message includes an indication of the alternative ATSSS steering functionality and steering mode based on the NE being capable of supporting the alternative ATSSS steering functionality and steering mode. Additionally, or alternatively, the at least one processor is operable to cause the UE 1000 to refrain from establishing the multi-access PDU session based on the response message including the one or more rules associated with the alternative ATSSS steering functionality and steering mode. Additionally, or alternatively, the at least one processor is operable to cause the UE 1000 to transmit, to an additional NE, a tunnel establishment request message that indicates a connect protocol for the MA PDU session, where the connect protocol includes at least one of an IP or an Ethernet protocol. Additionally, or alternatively, the at least one processor is operable to cause the UE 1000 to establish the MA PDU session in accordance with the connect protocol and the ATSSS steering functionality and steering mode. Additionally, or alternatively, the at least one processor is operable to cause the UE 1000 to receive, from the additional NE, an indication that the connect protocol is not allowed based on the message including the one or more rules associated with the alternative ATSSS steering functionality and steering mode.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

FIG. 10 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor 1100 to transmit, to an NE, a request message to establish an MA PDU session, where the request message includes an indication of an ATSSS steering functionality and steering mode for the MA PDU session, and receive, from the NE, a response message based on the request message, where the response message is associated with whether the NE is capable of supporting the ATSSS steering functionality and steering mode.

Additionally, the processor 1100 may be operable to or operable to support any one or combination of the response message includes a cause value indicating a rejection of the MA PDU session. Additionally, or alternatively, the cause value includes a 5GSM cause value or an ESM cause value. Additionally, or alternatively, the at least one controller is operable to cause the processor to transmit, to the NE, a subsequent request message to establish the MA PDU session, where the subsequent request message includes an indication of an alternative ATSSS steering functionality and steering mode for the MA PDU session based on the NE being capable of supporting the alternative ATSSS steering functionality and steering mode. Additionally, or alternatively, the at least one controller is operable to cause the processor to refrain from establishing the MA PDU session based on the cause value.

Additionally, or alternatively, the ATSSS steering functionality and steering mode includes at least one of an MPQUIC-IP functionality, an MPQUIC-E functionality, or an MPQUIC-UDP functionality, and the indication is included in an ATSSS steering functionality and steering mode information element field of a 5GSM capability information element. Additionally, or alternatively, the ATSSS steering functionality and steering mode includes an MPQUIC functionality, the indication is included in a 5GSM capability information element, and the 5GSM capability information element includes an indication of a connect protocol for the MA PDU session. Additionally, or alternatively, the ATSSS steering functionality and steering mode includes an MPQUIC functionality, the indication is included as an ATSSS request PCO parameter, and the request message further includes a tunneling indicator PCO parameter that indicates a connect protocol for the MA PDU session. Additionally, or alternatively, the response message includes an additional tunneling indicator PCO parameter that indicates an acknowledgement of the connect protocol, the tunneling indicator PCO parameter and the additional tunneling indicator PCO parameter share a same container identifier, and the at least one controller is operable to cause the processor to establish the MA PDU session according to the connect protocol based on receiving the response message.

Additionally, or alternatively, the ATSSS steering functionality and steering mode includes at least one of an MPQUIC-IP functionality or an MPQUIC-E functionality, and the response message includes one or more rules associated with an alternative ATSSS steering functionality and steering mode that includes an MPQUIC-UDP functionality. Additionally, or alternatively, the at least one controller is operable to cause the processor to transmit, to the NE, a subsequent request message to establish the MA PDU session, and the subsequent request message includes an indication of the alternative ATSSS steering functionality and steering mode based on the NE being capable of supporting the alternative ATSSS steering functionality and steering mode. Additionally, or alternatively, the at least one controller is operable to cause the processor to refrain from establishing the multi-access PDU session based on the response message including the one or more rules associated with the alternative ATSSS steering functionality and steering mode.

Additionally, or alternatively, the at least one controller is operable to cause the processor to transmit, to an additional NE, a tunnel establishment request message that indicates a connect protocol for the MA PDU session, where the connect protocol includes at least one of an IP or an Ethernet protocol. Additionally, or alternatively, the at least one controller is operable to cause the processor to establish the MA PDU session in accordance with the connect protocol and the ATSSS steering functionality and steering mode. Additionally, or alternatively, the at least one controller is operable to cause the processor to receive, from the additional NE, an indication that the connect protocol is not allowed based on the message including the one or more rules associated with the alternative ATSSS steering functionality and steering mode.

Additionally, the processor 1100 may be configured to or operable to support at least one controller (e.g., the controller 1102) coupled with at least one memory (e.g., the memory 1104) and configured to cause the processor 1100 to receive, from a UE, a request message to establish an MA PDU session, where the request message includes an indication of an ATSSS steering functionality and steering mode for the MA PDU session, and transmit, to the UE, a response message based on the request message, where the response message is associated with whether the processor 1100 is capable of supporting the ATSSS steering functionality and steering mode.

Additionally, the processor 1100 may be operable to or operable to support any one or combination of the response message includes a cause value indicating a rejection of the MA PDU session based on the processor 1100 lacking a capability to support the ATSSS steering functionality and steering mode. Additionally, or alternatively, the cause value includes a 5GSM cause value or an ESM cause value. Additionally, or alternatively, the at least one controller is operable to cause the processor 1100 to receive, from the UE, a subsequent request message to establish the MA PDU session, where the subsequent request message includes an indication of an alternative ATSSS steering functionality and steering mode for the MA PDU session based on the processor 1100 being capable of supporting the alternative ATSSS steering functionality and steering mode. Additionally, or alternatively, the ATSSS steering functionality and steering mode includes at least one of an MPQUIC-IP functionality, an MPQUIC-E functionality, or an MPQUIC-UDP functionality, and where the indication is included in an ATSSS steering functionality and steering mode information element field of a 5GSM capability information element. Additionally, or alternatively, the at least one controller is operable to cause the processor 1100 to establish the MA PDU session based on receiving the request message.

Additionally, or alternatively, the ATSSS steering functionality and steering mode includes an MPQUIC functionality, the indication is included in a 5GSM capability information element, and the 5GSM capability information element includes an indication of a connect protocol for the MA PDU session. Additionally, or alternatively, the ATSSS steering functionality and steering mode includes an MPQUIC functionality, the indication is included as an ATSSS request PCO parameter, and the request message further includes a tunneling indicator PCO parameter that indicates a connect protocol for the MA PDU session. Additionally, or alternatively, the response message includes an additional tunneling indicator PCO parameter that indicates an acknowledgement of the connect protocol, the tunneling indicator PCO parameter and the additional tunneling indicator PCO parameter share a same container identifier, and the at least one controller is operable to cause the processor 1100 to establish the MA PDU session according to the connect protocol based on receiving the request message. Additionally, or alternatively, the ATSSS steering functionality and steering mode includes at least one of an MPQUIC-IP functionality or an MPQUIC-E functionality, and where the response message includes one or more rules associated with an alternative ATSSS steering functionality and steering mode that includes an MPQUIC-UDP functionality.

Additionally, or alternatively, the at least one controller is operable to cause the processor 1100 to receive, from the UE, a subsequent request message to establish the MA PDU session, where the subsequent request message includes an indication of the alternative ATSSS steering functionality and steering mode based on the processor 1100 being capable of supporting the alternative ATSSS steering functionality and steering mode. Additionally, or alternatively, the at least one controller is operable to cause the processor 1100 to establish the MA PDU session based on receiving the subsequent request message.

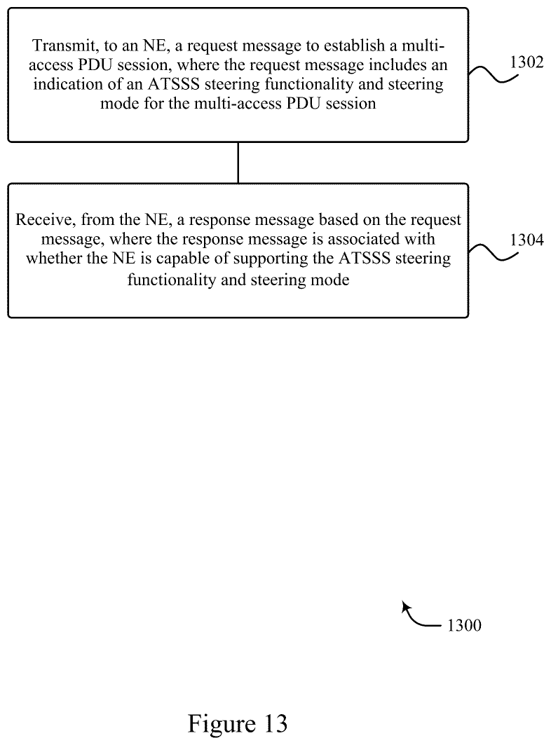

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for receiving, from a UE, a request message to establish an MA PDU session, where the request message includes an indication of an ATSSS steering functionality and steering mode for the MA PDU session, and transmitting, to the UE, a response message based on the request message, where the response message is associated with whether the NE 1200 is capable of supporting the ATSSS steering functionality and steering mode.

Additionally, the NE 1200 may be configured to or operable to support any one or combination of the response message includes a cause value indicating a rejection of the MA PDU session based on the NE 1200 lacking a capability to support the ATSSS steering functionality and steering mode. Additionally, or alternatively, the cause value includes a 5GSM cause value or an ESM cause value. Additionally, or alternatively, the method further comprises receiving, from the UE, a subsequent request message to establish the MA PDU session, where the subsequent request message includes an indication of an additional ATSSS steering functionality and steering mode for the MA PDU session based on the NE 1200 being capable of supporting the additional ATSSS steering functionality and steering mode. Additionally, or alternatively, the ATSSS steering functionality and steering mode includes at least one of an MPQUIC-IP functionality, an MPQUIC-E functionality, or an MPQUIC-UDP functionality, and where the indication is included in an ATSSS steering functionality and steering mode information element field of a 5GSM capability information element. Additionally, or alternatively, the method further comprises establishing the MA PDU session based on receiving the request message.

Additionally, or alternatively, the ATSSS steering functionality and steering mode includes an MPQUIC functionality, the indication is included in a 5GSM capability information element, and the 5GSM capability information element includes an indication of a connect protocol for the MA PDU session. Additionally, or alternatively, the ATSSS steering functionality and steering mode includes an MPQUIC functionality, the indication is included as an ATSSS request PCO parameter, and the request message further includes a tunneling indicator PCO parameter that indicates a connect protocol for the MA PDU session. Additionally, or alternatively, the response message includes an additional tunneling indicator PCO parameter that indicates an acknowledgement of the connect protocol, the tunneling indicator PCO parameter and the additional tunneling indicator PCO parameter share a same container identifier, and the method further comprises establishing the MA PDU session according to the connect protocol based on receiving the request message. Additionally, or alternatively, the ATSSS steering functionality and steering mode includes at least one of an MPQUIC-IP functionality or an MPQUIC-E functionality, and where the response message includes one or more rules associated with an alternative ATSSS steering functionality and steering mode that includes an MPQUIC-UDP functionality.

Additionally, or alternatively, the method further comprises receiving, from the UE, a subsequent request message to establish the MA PDU session, where the subsequent request message includes an indication of the alternative ATSSS steering functionality and steering mode based on the NE 1200 being capable of supporting the additional ATSSS steering functionality and steering mode. Additionally, or alternatively, the method further comprises establishing the MA PDU session based on receiving the additional request message.

Additionally, or alternatively, the NE 1200 may support at least one memory (e.g., the memory 1204) and at least one processor (e.g., the processor 1202) coupled with the at least one memory and configured to cause the NE 1200 to receive, from a UE, a request message to establish an MA PDU session, where the request message includes an indication of an ATSSS steering functionality and steering mode for the MA PDU session, and transmit, to the UE, a message based on the request message and whether the NE 1200 is capable of supporting the ATSSS steering functionality and steering mode.

Additionally, the NE 1200 may be operable to support any one or combination of the response message includes a cause value indicating a rejection of the MA PDU session based on the NE 1200 lacking a capability to support the ATSSS steering functionality and steering mode. Additionally, or alternatively, the cause value includes a 5GSM cause value or an ESM cause value. Additionally, or alternatively, the at least one processor is operable to cause the NE 1200 to receive, from the UE, a subsequent request message to establish the MA PDU session, where the subsequent request message includes an indication of an additional ATSSS steering functionality and steering mode for the MA PDU session based on the NE 1200 being capable of supporting the additional ATSSS steering functionality and steering mode. Additionally, or alternatively, the ATSSS steering functionality and steering mode includes at least one of an MPQUIC-IP functionality, an MPQUIC-E functionality, or an MPQUIC-UDP functionality, and where the indication is included in an ATSSS steering functionality and steering mode information element field of a 5GSM capability information element. Additionally, or alternatively, the at least one processor is operable to cause the NE 1200 to establish the MA PDU session based on receiving the request message.

Additionally, or alternatively, the ATSSS steering functionality and steering mode includes an MPQUIC functionality, the indication is included in a 5GSM capability information element, and the 5GSM capability information element includes an indication of a connect protocol for the MA PDU session. Additionally, or alternatively, the ATSSS steering functionality and steering mode includes an MPQUIC functionality, the indication is included as an ATSSS request PCO parameter, and the request message further includes a tunneling indicator PCO parameter that indicates a connect protocol for the MA PDU session. Additionally, or alternatively, the response message includes an additional tunneling indicator PCO parameter that indicates an acknowledgement of the connect protocol, the tunneling indicator PCO parameter and the additional tunneling indicator PCO parameter share a same container identifier, and the at least one processor is operable to cause the NE 1200 to establish the MA PDU session according to the connect protocol based on receiving the request message. Additionally, or alternatively, the ATSSS steering functionality and steering mode includes at least one of an MPQUIC-IP functionality or an MPQUIC-E functionality, and where the response message includes one or more rules associated with an alternative ATSSS steering functionality and steering mode that includes an MPQUIC-UDP functionality.

Additionally, or alternatively, the at least one processor is operable to cause the NE 1200 to receive, from the UE, a subsequent request message to establish the MA PDU session, where the subsequent request message includes an indication of the alternative ATSSS steering functionality and steering mode based on the NE 1200 being capable of supporting the additional ATSSS steering functionality and steering mode. Additionally, or alternatively, the at least one processor is operable to cause the NE 1200 to establish the MA PDU session based on receiving the additional request message.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

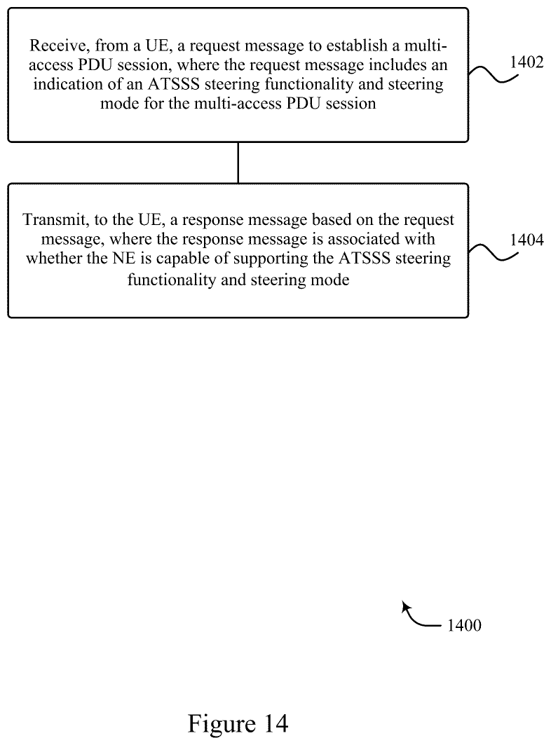

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include transmitting, to an NE, a request message to establish an MA PDU session, where the request message includes an indication of an ATSSS steering functionality and steering mode for the multi-access PDU session. The operations of 1302 may be performed in accordance with examples as described herein. In some implementations, aspects of the operations of 1302 may be performed by a UE as described with reference to FIG. 9.

At 1304, the method may include receiving, from the NE, a response message based on the request message, where the response message is associated with whether the NE is capable of supporting the ATSSS steering functionality and steering mode. The operations of 1304 may be performed in accordance with examples as described herein. In some implementations, aspects of the operations of 1304 may be performed by a UE as described with reference to FIG. 9.

FIG. 14 illustrates a flowchart of a method 1400 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

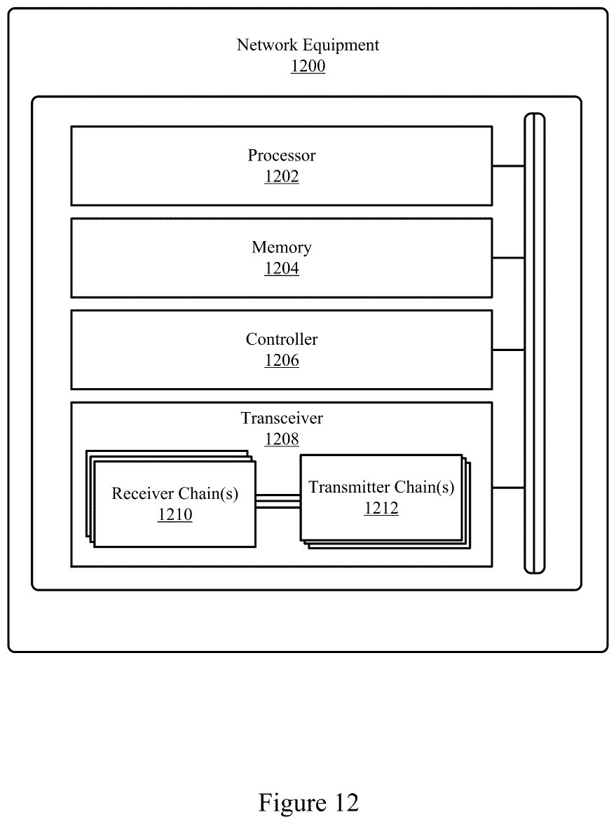

At 1402, the method may include receiving, from a UE, a request message to establish an MA PDU session, where the request message includes an indication of an ATSSS steering functionality and steering mode for the MA PDU session. The operations of 1402 may be performed in accordance with examples as described herein. In some implementations, aspects of the operations of 1402 may be performed by a NE as described with reference to FIG. 11.

At 1404, the method may include transmitting, to the UE, a response message based on the request message, where the response message is associated with whether the NE is capable of supporting the ATSSS steering functionality and steering mode. The operations of 1404 may be performed in accordance with examples as described herein. In some implementations, aspects of the operations of 1404 may be performed by a NE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit, to a network equipment (NE), a request message to establish a multi-access protocol data unit (PDU) session, wherein the request message includes an indication of an access traffic steering-switching-splitting (ATSSS) steering functionality and steering mode for the multi-access PDU session; and
receive, from the NE, a response message based at least in part on the request message, wherein the response message is associated with whether the NE is capable of supporting the ATSSS steering functionality and steering mode.

2. The UE of claim 1, wherein the response message includes a cause value indicating a rejection of the multi-access PDU session.

3. The UE of claim 2, wherein the cause value comprises a fifth generation (5G) session management (5GSM) cause value or an evolved packet system (EPS) session management (ESM) cause value.

4. The UE of claim 2, wherein the at least one processor is operable to cause the UE to transmit, to the NE, a subsequent request message to establish the multi-access PDU session, wherein the subsequent request message includes an indication of an alternative ATSSS steering functionality and steering mode for the multi-access PDU session based at least in part on the NE being capable of supporting the alternative ATSSS steering functionality and steering mode.

5. The UE of claim 2, wherein the at least one processor is operable to cause the UE to refrain from establishing the multi-access PDU session based at least in part on the cause value.

6. The UE of claim 1, wherein the ATSSS steering functionality and steering mode comprises at least one of a multipath QUIC (MPQUIC) Internet protocol (MPQUIC-IP) functionality, an MPQUIC Ethernet (MPQUIC-E) functionality, or an MPQUIC user datagram protocol (UDP) functionality, and wherein the indication is included in an ATSSS steering functionality and steering mode information element field of a fifth generation (5G) session management (5GSM) capability information element.

7. The UE of claim 1, wherein:
the ATSSS steering functionality and steering mode comprises a multipath QUIC (MPQUIC) functionality;
the indication is included in a fifth generation (5G) session management (5GSM) capability information element; and
the 5GSM capability information element includes an indication of a connect protocol for the multi-access PDU session.

8. The UE of claim 1, wherein:
the ATSSS steering functionality and steering mode comprises a multipath QUIC (MPQUIC) functionality;
the indication is included as an ATSSS request protocol configuration options (PCO) parameter; and
the request message further includes a tunneling indicator PCO parameter that indicates a connect protocol for the multi-access PDU session.

9. The UE of claim 8, wherein:
the response message includes an additional tunneling indicator PCO parameter that indicates an acknowledgement of the connect protocol;
the tunneling indicator PCO parameter and the additional tunneling indicator PCO parameter share a same container identifier; and
the at least one processor is operable to cause the UE to establish the multi-access PDU session according to the connect protocol based at least in part on receiving the response message.

10. The UE of claim 1, wherein the ATSSS steering functionality and steering mode comprises at least one of a multipath QUIC (MPQUIC) internet protocol (MPQUIC-IP) functionality or an MPQUIC Ethernet (MPQUIC-E) functionality, and wherein the response message includes one or more rules associated with an alternative ATSSS steering functionality and steering mode that comprises an MPQUIC user datagram protocol (MPQUIC-UDP) functionality.

11. The UE of claim 10, wherein the at least one processor is operable to cause the UE to transmit, to the NE, a subsequent request message to establish the multi-access PDU session, wherein the subsequent request message includes an indication of the alternative ATSSS steering functionality and steering mode based at least in part on the NE being capable of supporting the alternative ATSSS steering functionality and steering mode.

12. The UE of claim 10, wherein the at least one processor is operable to cause the UE to refrain from establishing the multi-access PDU session based at least in part on the response message including the one or more rules associated with the alternative ATSSS steering functionality and steering mode.

13. A network equipment (NE) for wireless communication, comprising:
at least one memory; and
at least one processor coupled with the at least one memory and operable to cause the NE to:
receive, from a user equipment (UE), a request message to establish a multi-access protocol data unit (PDU) session, wherein the request message includes an indication of an access traffic steering-switching-splitting (ATSSS) steering functionality and steering mode for the multi-access PDU session; and
transmit, to the UE, a response message based at least in part on the request message, wherein the response message is associated with whether the NE is capable of supporting the ATSSS steering functionality and steering mode.

14. The NE of claim 13, wherein the response message includes a cause value indicating a rejection of the multi-access PDU session based at least in part on the NE lacking a capability to support the ATSSS steering functionality and steering mode.

15. The NE of claim 14, wherein the cause value includes a fifth generation (5G) session management (5GSM) cause value or an evolved packet system (EPS) session management (ESM) cause value.

16. The NE of claim 14, wherein the at least one processor is operable to cause the NE to receive, from the UE, a subsequent request message to establish the multi-access PDU session, wherein the subsequent request message includes an indication of an alternative ATSSS steering functionality and steering mode for the multi-access PDU session based at least in part on the NE being capable of supporting the alternative ATSSS steering functionality and steering mode.

17. The NE of claim 13, wherein the ATSSS steering functionality and steering mode comprises at least one of a multipath QUIC (MPQUIC) internet protocol (MPQUIC-IP) functionality, an MPQUIC Ethernet (MPQUIC-E) functionality, or an MPQUIC user datagram protocol (UDP) functionality, and wherein the indication is included in an ATSSS steering functionality and steering mode information element field of a fifth generation (5G) session management (5GSM) capability information element.

18. The NE of claim 17, wherein the at least one processor is operable to cause the NE to establish the multi-access PDU session based at least in part on receiving the request message.

19. A method performed by a user equipment (UE), the method comprising:
transmitting, to a network equipment (NE), a request message to establish a multi-access protocol data unit (PDU) session, wherein the request message includes an indication of an access traffic steering-switching-splitting (ATSSS) steering functionality and steering mode for the multi-access PDU session; and
receiving, from the NE, a response message based at least in part on the request message, wherein the response message is associated with whether the NE is capable of supporting the ATSSS steering functionality and steering mode.

20. A method performed by a network equipment (NE), the method comprising:
receiving, from a user equipment (UE), a request message to establish a multi-access protocol data unit (PDU) session, wherein the request message includes an indication of an access traffic steering-switching-splitting (ATSSS) steering functionality and steering mode for the multi-access PDU session; and
transmitting, to the UE, a response message based at least in part on the request message, wherein the response message is associated with whether the NE is capable of supporting the ATSSS steering functionality and steering mode.
